(19) United States
(12) Patent Application Publication
(10) Pub. No.: US 2005/0125261 A1
(43) Pub. Date: Jun. 9, 2005

(54) Intelligent used parts cross-referencing, search and location software application

(75) Inventor: Alexander Omeed Adegan, Los Angeles, CA (US)

Correspondence Address: STAAS & HALSEY LLP, SUITE 700, 1201 NEW YORK AVENUE, N.W., WASHINGTON, DC, 20005, US

(73) Assignee: Alexander Omeed Adegan, Los Angeles, CA (US)

(21) Appl. No.: 11/007,589

(22) Filed: Dec. 9, 2004

Related U.S. Application Data
(60) Provisional application No. 60/527,762, filed on Dec. 9, 2003.

(51) Int. Cl. G06F 17/60

(52) U.S. Cl. 705/4

(57) ABSTRACT

Dynamically and intelligently identifying used parts and automatically locating actual used parts. A programmed computer system receiving an electronic vehicle repair estimate with a new part, type cross referencing a type of the new part in the estimate with a type of a used part, according to a used part type database, cross referencing the type of the used part with a used part identifier, according to a used part identifier database, identifying actual used parts corresponding to the new part by searching a used parts database based on the used parts identifier.

### CROSS REFERENCE TO RELATED APPLICATION

This application claims priority under 35 USC 119 from U.S. Provisional Application Ser. No. 60/527,762 entitled “INTELLIGENT USED AUTO PARTS LOCATING SOFTWARE APPLICATION,” filed on Dec. 9, 2003, the contents of which is hereby fully incorporated herein by reference.

### BACKGROUND OF THE INVENTION

1. Field of the Invention

The present invention relates to dynamically identifying used parts and automatically locating these parts. More particularly, the present invention relates to dynamically and automatically identifying used vehicle (e.g., automobile/truck) parts corresponding to new or Original Equipment Manufacture (OEM), or aftermarket automobile/truck parts.

2. Description of the Related Art

There are three types of auto parts in the automotive industry. OEM parts (brand new parts utilized by manufacturers in creating a vehicle), Aftermarket (or AM) parts (alternatives parts supplied by non-manufacturers as a cheaper substitute for OEM parts), and used parts (also known as salvage parts, recycled parts, or LKQ, Like Kind & Quality parts), used parts are often OEM parts, but have been previously used, or are second hand. The part numbering system for each of these part types are entirely different. In other words, an alternator for a given vehicle in the OEM world may have a part number ABX1023403. This same alternator in the used-parts world may have a used-part number XYZ222314. Therefore there is a need for automatic cross-referencing of these different part types (i.e. from the OEM/aftermarket world to that of the used part world) in order to systematically identify, search and procure used parts in place of their more expensive OEM or aftermarket equivalents.

Each of these automobile part types employ an entirely different part numbering system. One would think that a Left Front Fender for a 1998 BMW 325i, is described as such with either an “OEM”, “aftermarket”, or “used” in front of it, and that would be only requirement to properly describe the different part types (i.e. OEM, aftermarket, or used). This is not the case. These part numbering systems and identification methods differ widely from one industry to another. To a point that it is not practicable to create a one-to-one lookup system, that given one part number (e.g. OEM parts) one could look up it's corresponding part number in the second category (e.g. used parts).

OEM part manufacturers and automakers have for years employed varying part numbering systems that they utilize for their internal purposes and for proper identification of their parts.

On the other hand, the “used auto part” part numbering system was developed by Roy Hollander in the early 1920s and published as the “HOLLANDER INTERCHANGE MANUAL” as a 125-page document in 1934. This Manual has been utilized by recycled parts suppliers (also known as salvage yards, wrecking yards, etc.) to correctly identify used automobile parts for various vehicles. This manual was put together and enhanced over the years, based on observations and feedback from thousands of automobile recyclers, repair shops, and mechanics. As computers became more prevalent, the HOLLANDER INTERCHANGE MANUAL was converted into an electronic numbering system (hereinafter referred to as the HOLLANDER INTERCHANGE PART NUMBERING SYSTEM) for proper identification of used (recycled) automobile parts. There are publicly accessible Internet web sites that allow for identification and search of used automobile parts where such process relies on the HOLLANDER INTERCHANGE NUMBER.

There are a number of existing methods for locating and utilization of used auto parts. These methods invariably involve manual location of these products via an insurance estimator, or an individual employed at the repair facility where a repair is undertaken and used parts are utilized, or third party experts familiar with estimate creation/analysis and the part numbering systems in the OEM, aftermarket and used parts industries. A suite of software applications, known as estimating applications, aid collision repair facilities in creation of an accurate repair estimate as to the extent of damage to one's vehicle and costs associated with its repair and restoration to the pre-accident condition. These estimates mainly contain two components of labor and parts. Estimating applications have incorporated sophisticated means for analysis, and calculation of labor related to disassembly and installation of various vehicle makes, models and years. For example, they help an estimator produce a fairly accurate estimate as to how much labor is necessary to repair a 1998 BMW 325i series that has a front-right-hand side damage on its right fender.

These calculations are combined with the total cost of parts required to carry out the repair for a given vehicle. Estimators use part pricing, available to them at the time of the estimate in order to create an estimate for repair of a given vehicle. In case of used parts, these part pricing information is derived from either a Compact Disk, or an online connection where part availability and pricing may be accessible to an individual estimator. Estimators are required to manually determine the type of used parts necessary to carry out a repair, and are instructed to insert a given part type, along with its AVERAGE price into a repair estimate. The methods used by estimators at the time of creation of an estimate require the estimator to have an in-depth knowledge of the used parts industry, and its nomenclature, and to make a conscious decision as to which parts to insert, and where to obtain those parts. The most advanced methods of part pricing for used auto parts thus far, involve estimators familiar with recycled part numbering system to perform queries on these databases, obtain part pricing information, and, using their knowledge of used auto parts, inserting this information in the estimate in place of one or more OEM or aftermarket parts.

Conventionally, companies employ tens of people to manually determine which OEM parts from an estimate correspond to which used parts, and to call various suppliers in order to obtain current part pricing and location information prior to inserting that information (i.e. part name, price, location, etc.) into a repair estimate. These companies lack the sophistication, efficiency and the built-in intelligence that is the foundation of the current invention. Their processes are highly manual and require human operators to read estimates that are sent to them via: fax, e-mail, or electronically. They will then examine the content of these estimates for opportunities to replace any of the parts within a given estimate with their equivalent recycled parts. In order to obtain part pricing and availability they contact part suppliers directly and convey their findings to the estimator through fax, e-mail, or with additional telephone calls.

The above methods are mostly manual. They result in a search method that is impractical, costly, and lacking the user of any systematic way to ensure that the most desirable and least expensive parts are utilized for a given repair. Involvement of a human operator at all stages of searching for a number of recycled parts that can be obtained from several thousand suppliers with different warranties, pricing, and quality is error prone, extremely inefficient (slow due to requirements for reading the estimate, calling suppliers, receiving/sending faxes, etc.), and quite expensive to operate and therefore not cost-effective.

One example of using such manual processes involves enlisted call-centers that employ individuals familiar with the used automobile parts space. These individuals receive faxes containing lists of OEM parts that are used in repair estimates. They each read the list of parts and determine as to what used parts can possibly replace the existing OEM parts (currently listed on the estimate) in order to reduce the cost of repair. The call center operators will then contact a handful of known suppliers by phone in order to determine the best source for securing those parts. Once they get an oral confirmation from the suppliers as to availability of those parts, they will call the repair facility and inform them of existence of those parts, providing the suppliers contact information, while asking them to contact the suppliers in order to obtain those parts.

Accordingly, there is a need to fully automate the used part identification and location process by systematically cross-referencing the existing OEM and aftermarket parts within a given estimate to that of their equivalent used parts, and intelligently searching and locating those parts.

### BRIEF DESCRIPTION OF THE DRAWINGS

The above and/or other aspects and advantages of the invention will become apparent and more readily appreciated from the following description of the embodiments, taken in conjunction with the accompanying drawings of which:

FIG. 1 is a functional block diagram of the overall architecture of the parts application according to an embodiment of the present invention. Although not all the elements within this figure are necessary for the current invention to function properly, the current invention does interact with most of the elements represented in this figure.

FIG. 2 is a flowchart diagram that describes the broad operations that take place from a time an electronic estimate is received by the infrastructure housing the current invention, to the time that a corresponding Bundle of parts, or a repair estimate supplement in the original estimating system format is generated and forwarded to a third party such as a repair facility or insurance company agent.

FIG. 3A represents the flowchart for the first step of the current invention's algorithms that properly identify and cross-reference each part in a given repair estimate with that of their equivalent used part type.

FIG. 3B Further describes the aspect of the current invention that is responsible for identifying the correct Interchange number that needs to be designated in the Search and Populate Process that follow the part cross-referencing method. It also describes the methods used for proper matching of any “used part assemblies” to that of their corresponding components.

FIG. 3C depicts the algorithms that are carried out for proper identification of the correct Interchange Number based on the existing inventory database of recyclers who have previously listed their parts using VIN numbers and Hollander Interchange Numbers.

FIG. 4 is a flowchart describing the algorithms that the current invention utilizes in order to properly search for, and populate the set of used parts and their HOLLANDER INTERCHANGE NUMBERS that were generated as a result of the Bundle Part Cross-referencing Algorithm described in FIG. 3.

FIG. 5 is a representation of the user interface of a Bundle. It depicts the Bundle Viewer component of the current invention that allows easy viewing, and manipulation of the Bundle generated as a result of the current invention's operation through a simple web-based user interface.

FIG. 6A depicts the various states that a Bundle of parts go through as different algorithms of the current invention are applied to it.

FIG. 6B represents the relationship between the states and the processes that are applied to the Bundle of parts as they transition through the current invention.

FIG. 7A represents the Bundle Search page of the current algorithm which allows direct specification of used parts, and their search through a web-based user interface.

FIG. 7B is an image of the Bundle Search page, which is a web-based user interface that allows users to enter their Bundle Search criteria, and perform a search.

FIG. 8 is a diagram of the overall context in which different parties to the repair estimate provide and receive various elements involved in the reception of repair estimates, as well as generation and broadcast of parts Bundles.

FIG. 9 is a snapshot of the search preferences that can be set by anyone interested in receiving Bundles generated as a result of the actions taken by the current invention. These settings can be set by insurance companies, repair shops, or anyone else interested in analysis of their repair estimates.

FIG. 10 is representation of a generic sample repair estimate as it would be presented to a consumer interested in repairing his or her vehicle. It identifies many of the different fields that the current invention takes advantage of when performing its operations.

FIG. 11 is a snapshot of the current invention's “contact seller” page. This page allows the users of Bundles generated by the current invention to contact each other through a feature of the current invention called uConnect.

FIG. 12 is a diagram of the uConnect feature of the current invention. It depicts the relationships between various parties, and computer components that utilize this feature.

FIG. 13 is a snapshot of the uConnect status page. This page displays, in real-time, the operations that are being taken by the uConnect feature.

### A DETAILED DESCRIPTION OF THE PREFERRED EMBODIMENTS

Reference will now be made in detail to example embodiments of the present invention, which are illustrated in the accompanying drawings, wherein like reference numerals refer to the like elements throughout. The example embodiments are described below to explain the present invention by referring to the figures.

HOLLANDER INTERCHANGE USED PART NUMBERING SYSTEM, significantly improves the ability of any used-parts search system by providing a number of different capabilities. The current invention's main accomplishment lies in its ability to perform a HOLLANDER INTERCHANGE NUMBER search of used automobile parts, where no such information (i.e. HOLLANDER INTERCHANGE information) is specified by the individual who has put together a repair estimate. In one embodiment of the current invention these part specifications are obtained from the line-items created in repair estimates by a suite of software applications known as estimating software. As of date of this document none of the current estimating systems provide any HOLLANDER INTERCHANGE NUMBERING information when specifying a part-type entry in either the HEADER, or their DESCRIPTION FIELDS.

The current invention enables it's operators to properly cross-reference the information that is provided in an electronic repair estimate, to that of the HOLLANDER INTERCHANGE NUMBERING SYSTEM. This allows the current invention to take advantage of the benefits of using this numbering system for searching various databases of hundreds of millions of used automobile parts. A great majority modern Inventory Management Systems utilized by today's automobile recyclers, make use of the HOLLANDER INTERCHANGE PART NUMBERING SYSTEM to catalogue their inventory of tens of thousands of used-parts that they have dismantled from inoperable vehicles that they have acquired to salvage their parts. The lion's share of these parts are listed in the Inventory Management System using the HOLLANDER INTERCHANGE PART NUMBERING SYSTEM.

Utilizing the HOLLANDER INTERCHANGE PART NUMBERING SYSTEM to search and locate used automobile parts is much more effective for many different reasons including: A) Since used-parts are cataloged using the HOLLANDER INTERCHANGE PART NUMBERING SYSTEM, these parts can best be searched-for using this numbering system. B) The HOLLANDER INTERCHANGE PART NUMBERING SYSTEM takes into account which parts are “INTERCHANGEABLE” with which parts. For example a 1995 Ford Taurus has the same exact same Engine as a 1994 Mercury Sable. The HOLLANDER INTERCHANGE PART NUMBERING SYSTEM has taken this into consideration and therefore produces search results which include Mercury Sable Engines, when one searches for Ford Taurus Engines for the correct year range. C) The Hollander Interchange information has also embedded the Side Information (i.e. Left or Right) into it's numbering system, therefore eliminating, or substantially reducing the need to specifying side information when performing queries for used-auto parts. D) The Sub-model vehicle information is also an integral part of the HOLLANDER INTERCHANGE PART NUMBERING SYSTEM. This feature allows the searching party to further specify the Sub-model of the vehicle being searched. For example, a 1999 Honda Accord has a DX, LX, EX models along with a V6 model all of which are reflected in the HOLLANDER INTERCHANGE PART NUMBERING SYSTEM, and can be queried using that numbering system. E) The HOLLANDER INTERCHANGE PART NUMBERING SYSTEM has also incorporated the year-range of the parts that are the same for a given vehicle. For instance, the 2000 Range Rover from Land Rover, has the same Engine as the year 2001, and 2002 Range Rover from Land Rover, and therefore, their engines can easily be Interchanged. In other words, one can supply the engine from a year 2001 vehicle to replace an engine for a year 2000 vehicle. These characteristics of the HOLLANDER INTERCHANGE PART NUMBERING SYSTEM can easily be learned from publicly accessible used auto part search web sites. Anyone familiar with the used-part industry is fully aware of the advantages described in sections A through E of this paragraph.

These features of the HOLLANDER INTERCHANGE PART NUMBERING SYSTEM significantly increase the breadth and accuracy of the search, and therefore the efficacy of the current invention. This aspect of the current invention's ability to determine the correct INTERCHANGE PART NUMBER automatically, and to carry out the search without any human intervention, eliminates (or in some cases significantly reduces) the need for human operators to examine the content of a given repair estimate in order to determine what are the correct “used” parts (based on HOLLANDER INTERCHANGE PART NUMBERING SYSTEM) that can replace any existing OEM, and/or aftermarket parts listed in a that estimate.

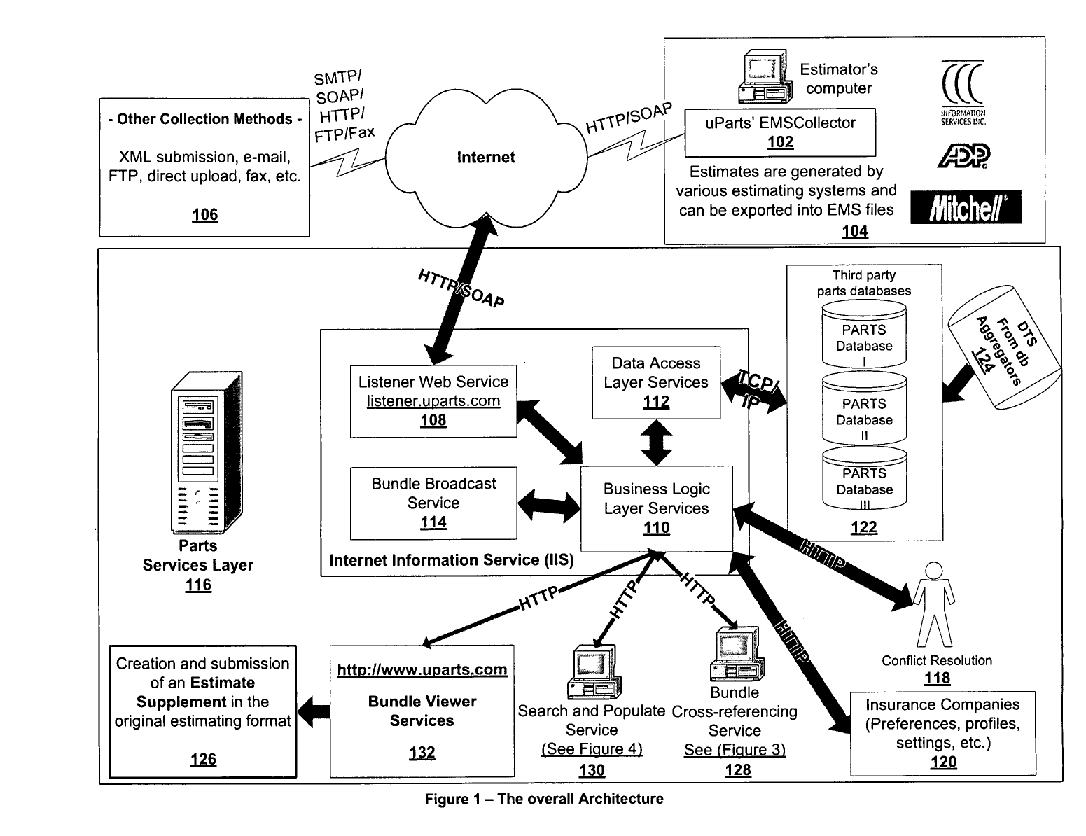

Advances and cost-effective communications means provided by the Internet, coupled with the availability of estimates in electronic format, have provided the foundation for the viability of the current invention. The current invention is capable of efficiently and cost-effectively cross-reference any estimate line-item containing OEM or aftermarket part data to that of used-part numbers. However, the most common electronic estimate format that is currently utilized by the industry is the EMS (Estimating Management System) that was developed by CIECA (Collision Industry E-Commerce Association). All major estimating software applications currently have a built-in capability to export the entire estimate into this common format. One embodiment of the current invention, retrieves these EMS files from the computer (as depicted in box 104 of FIG. 1) on which the estimate was created, and electronically transmits them, through a collection application, 102, over the Internet, to the a web service known as the Listener, 108. This listener service, 108, is constantly listening for transmission of electronic estimates generated by various estimating systems, 104. As soon as an estimate arrives, 104, the Listener 108, which will then log it's information, and passes it to the Business Logic Layer Services, 110. The Business Logic Layer Services, 110, are responsible for proper cross-referencing, identification, and search of the parts listed within any given estimate.

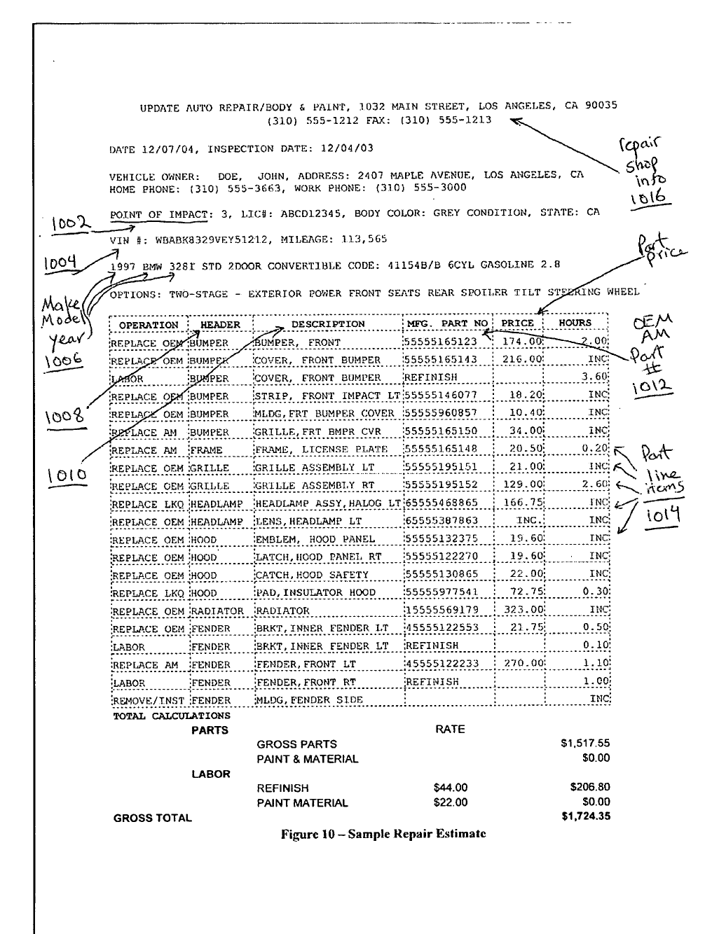

Some background information about the two important fields provided in repair estimates, 104. Please review “Sample Repair Estimate—FIG. 10”. The line-items, 1014, in repair estimates, 104, often (depending on the estimating software) have two different fields, the HEADER field, 1008, and the DESCRIPTION, 1010, field (depicted in Columns of the “Sample Repair Estimate—FIG. 10”). There are also other fields such as “point of impact”, 1002, (i.e. the primary and secondary areas that the vehicle under repair was impacted and damaged), and VIN #, 1004, Make, Model, and Year, 1006, of the vehicle that are utilized by the current invention for its proper cross-referencing. Also, the repair shops information, 1016, is obtained from the repair estimate as well. The proper cross-referencing of the HEADER, 1008, and the DESCRIPTION, 1010, fields of the estimate are of utmost importance to the operation of the current invention. Although the HEADER, 1008, field does not always exist in all estimating systems it is utilized by the current invention to algorithmically determine the correct part type corresponding to each OEM/aftermarket part in the repair estimate line-items. The HEADER field, 1008, contains major component names such as FRONT DOOR, FENDER, FRONT BUMPER, HOOD, etc. These major components are then further defined in the DESCRIPTION, 1010, field. Values in the DESCRIPTION, 1010, field provide additional detail in cases where the HEADER, 1008, field exists and complete information in cases where the HEADER field does not exist (depending on the estimating software). Examples of the content of the description field include: “FENDER, FRONT, LT”, “FRT BUMPER COVER”, “DOOR SHELL, FRONT LT”, “HNDL, FRT DR LT”. The values in the DESCRIPTION field are in a “free-text” format. This means they are not selected from an existing list of predefined values. They are entered into the description field by insurance adjusters, staff appraisers, or anyone else who has created the estimate.

Two other pieces of information that are utilized by the current invention in its algorithmic approach to automatic part identification and cross-referencing are the Primary/Secondary Points of Impact, 1002, and the Side information provided on each line-item DESCRIPTION field (“LT”, or “RT” in the table) as described in the previous paragraph. The current invention takes into consideration the sides of impact specified in the repair estimate when there is no side information specified in the line-item for a given part. Thus, the line-item side specification takes precedence over the “point of impact” specification. Most estimators specify a “LT” or “RT” for LEFT or RIGHT side parts whenever relevant. For example, a left side door cannot be used in place of a right side door.

Most estimating systems today, specify two “points of impact”: A Primary, and a Secondary “point of impact”. These estimating systems utilize about twenty different keywords in either the Primary point of impact alone; or both in the Primary and the Secondary points of Impact. Examples of these keywords are: LEFT FRONT, LEFT QUARTER POST, LEFT REAR, LEFT T-BONE, RIGHT FRONT PILLAR, RIGHT QUARTER POST, ROLLOVER, ROOF, etc. The current invention takes into consideration these keywords when attempting to cross-reference part-types. For example if an estimate has specified that a vehicle has only had a REAR-RIGHT collision as a Primary point of impact, and there is no Secondary Point of Impact, and we have not been able to determine whether a given part (e.g. a QUARTER PANEL) listed in the estimate is a LEFT side or a RIGHT side quarter panel, because no such information was provided in the line-item's DESCRIPTION field, the current invention will take into consideration the repair estimate's Points of Impact for determining the correct side for the QUARTER PANEL.

Another important contributor to the current invention is the more consistent availability of the Vehicle Identification Number (or VIN), 1004, on both, estimates generated using an estimating system, as well as used parts databases that aggregate data from computerized Inventory Management Systems of automobile recyclers, or used-parts suppliers. The current invention takes full advantage of the VIN, 1004, by parsing it down to its components, and utilizing these components for more effective cross-referencing between the part information in the estimate and that of the part inventory database. This cross-references are ultimately cataloged in an “artificial intelligence” database of the current invention, cross-referencing the OEM/AM part number, 1012, of the line-item, with that of its corresponding used part identifier.

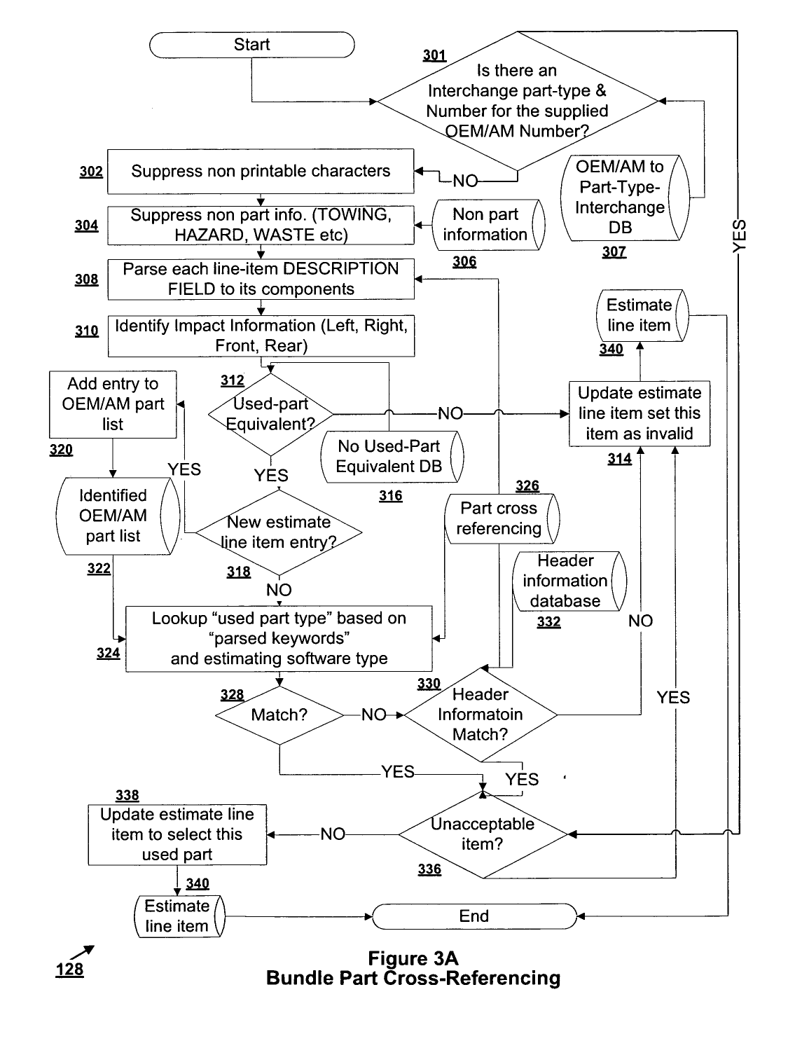

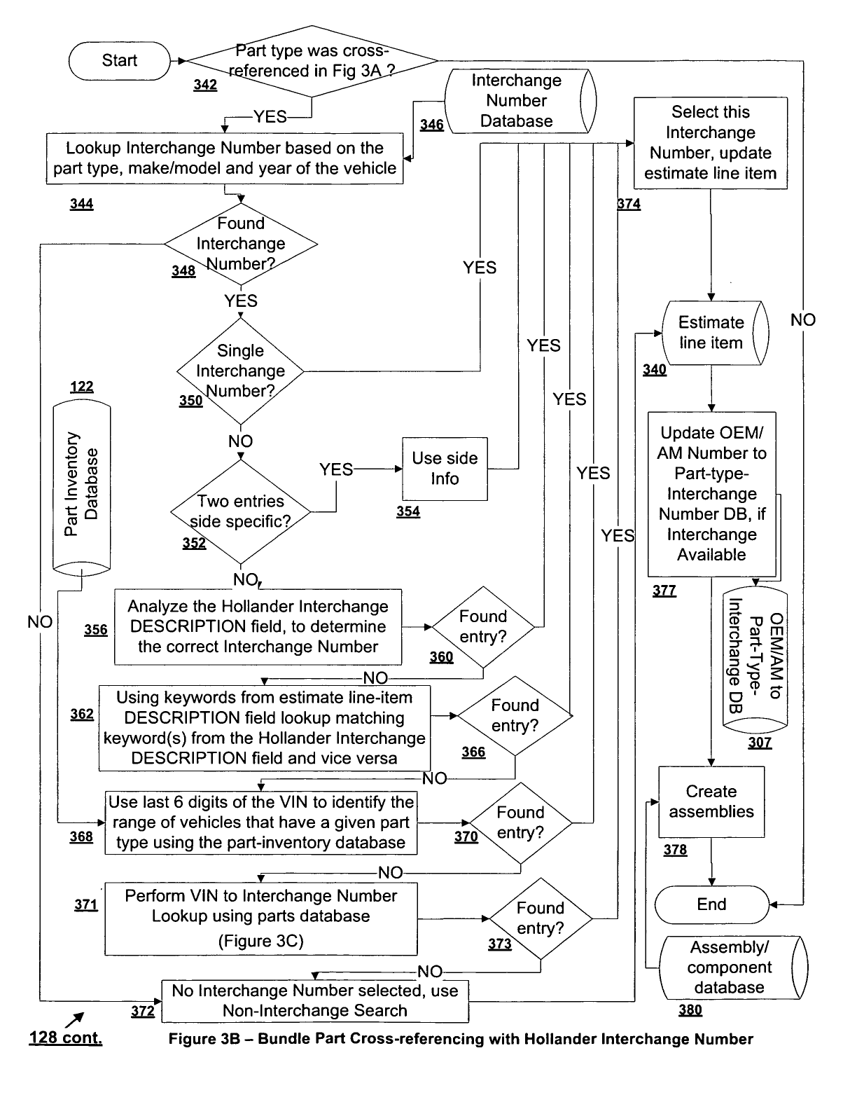

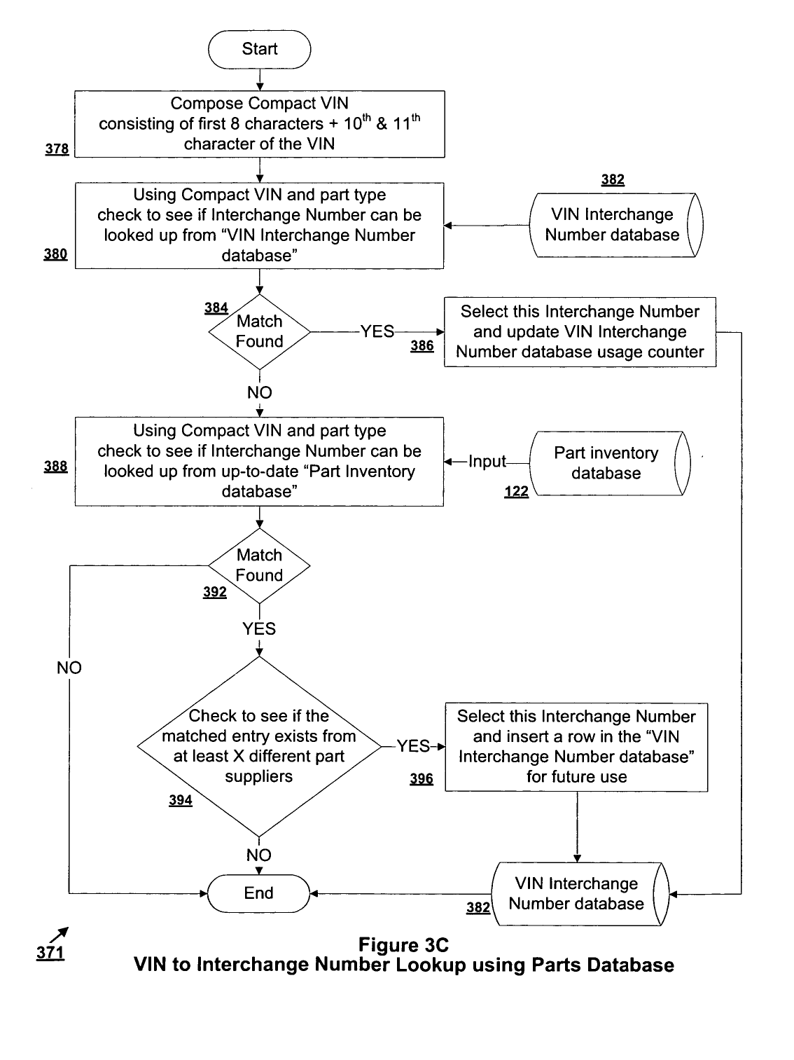

The following two paragraphs provide background information relating to FIG. 3B, 368, of the current invention, relating to further analysis of the Vehicle Identification Number's last 6 digits to facilitate further identification of the correct used part type and HOLLANDER INTERCHANGE NUMBER. Vehicles newer than the year 1980, have a 17 digit VIN (Vehicle Identification Number). 11 of these 17 digits properly identify the make, model, year, country of manufacture, engine size, driveline, fuel type, airbag, and a few other general vehicle information. However, the first 11 digits are not always sufficient for determining the exact part detail information necessary for selecting the correct part type for a given vehicle. For example, the VIN does not specify the moldings for a given vehicle. And since there can be several different moldings for a given make, year, and model, it is impractical to search for and locate a fender, or bumper that has the correct molding without first asking the estimator what is the desired molding type. The current invention remedies this problem by examining the 6 digit range of the Vehicle Identification Number, and properly categorizing the molding types, colors, and a multitude of other characteristics within the correct range of the VIN number.

The current invention takes into consideration the fact that different characteristics for a given vehicle make, model and year are grouped into the same Vehicle Identification Number range. For example, a 2000 Land Rover, Range Rover 4.6 HSE has the following characters in its first 11 digits of the Vehicle Identification Number: SALPV1657YA. This number is followed by 6 digits that uniquely identify an actual vehicle. For example, the VIN number for a particular vehicle could be SALPV165YA444653. For the sake of this example lets assume that the range of VIN numbers 444000 to 450000 identify the 6,000 year-2000 Range Rovers (starting with VIN SALPV1657YA) that have double striped moldings, and the range of VIN numbers 450000 to 458000 could identify the 8,000 year-2000 Range Rovers (starting with VIN SALPV1657YA) that have a single striped molding. The current invention takes into consideration this information (derived from a third party database, or a database that has been accumulated based on prior matches carried out either algorithmically or manually by the operators of the current invention) to properly identify the used part with the correct molding, or any other characteristics for a given used part that is not specific to the vehicle's first 11 characters of the VIN number.

It is important to stress the point that the used part industry utilizes a completely different part numbering system and methodology for describing and using used parts than do the OEM and aftermarket part industries. The first purpose of this invention is to create a software application that utilizes a set of sophisticated algorithms that intelligently perform cross-referencing between the OEM/aftermarket parts, and that of used parts. Moreover, the current invention takes advantages of artificial intelligence to learn the proper part cross-referencing between the used part industry, and the OEM/AM part industry. The current invention then utilizes the generated used-parts numbers (derived from the OEM/aftermarket parts listed in the estimate) in order to electronically search and locate the most desirable used-parts based on preferences set by the parties responsible for carrying out the repair (i.e. the insurance company, the repair facility, etc.)

These preferences can be set by either the insurance company financing the repair, or the repair facilities carrying out the repair, and can include characteristics such as distance of the used parts from the repair facility, the extent of warranty that the part supplier provides, quality of the part, part price, etc. The current invention, electronically, and automatically analyzes repair estimates that contain millions of part listings. These listings can be in the form of OEM parts, aftermarket parts, or used parts. The current invention, then automatically cross-references the OEM parts with their equivalent used parts, creating a “shopping list” (or a Bundle) of used parts. These parts are then automatically searched for through our database of used parts, and matches are selected according to preset criteria. Results are finally compiled and sent along the estimate to the repair facility in a form of an attachment, or e-mailed directly to the repair facility contact person, or faxed to a specified fax number. Additionally, the current invention is capable of learning from its past-behavior, or behavior of human operators that make any occasional corrections to the system. These behaviors are recorded in the artificial intelligence database of the present invention, to be utilized any time in the future when the same OEM/aftermarket parts need to be cross-referenced to their equivalent used part.

The current invention eliminates or significantly reduces the need for claims professionals (either insurance adjusters, or repair facility personnel, or anyone else) to search and locate used parts and insert them in repair estimates. Estimates can now be written using readily accessible OEM parts. Once an estimate is written and electronically submitted for review to the insurance company, it can then be evaluated by the current invention, for opportunities to replace existing OEM parts with their used equivalent parts. This process can save insurance companies, repair facilities, and ultimately the end consumer millions of dollars in cost of their repair. One of the major problems solved by the current invention is the automatic cross-referencing of OEM parts with their equivalent used parts. This is done through a sophisticated algorithm described in more detail further below.

The current invention requires a sophisticated group of software applications to effectively communicate with each other. In order for this invention to function properly, it needs to electronically access several different software components.

The software components in the Parts Services Layer, 116, of FIG. 1, can utilize a variety of software applications such as database applications from ORACLE, SYBASE, MICROSOFT SQL SERVER DATABASE, etc., capable of producing XML data (or other generic data) for consumption by a listener object 108, over the Internet. These databases typically contain insurance estimates including all of their pertinent fields such as vehicle information, line-items, and their HEADER and DESCRIPTION FIELDS, repair facility information, total value of the estimate, list of all the parts that need to be replaced for a given repair along with their pricing, name, and contact information of all the parties involved in the repair process. As well as individuals from the insurance company, the repair facility, owner of the vehicle, and other people who may be involved in the repair process.

These estimates, 104, and all of their related information are then electronically transmitted to computer servers, 116, accessible by the current invention. The estimates are generally received in the industry EMS format known as Estimating Management System. One component of the invention will then receive these estimates and send an acknowledgement back to the sender as to successful receipt of such estimate. Once a copy of an electronic estimate, FIG. 10-Sample Repair Estimate, is received by the infrastructure housing the current invention, 116, the system begins processing of the estimate. The first step in this process involves extraction of all the parts that are listed in the EMS file (or other file structures) containing the estimate, in order to analyze and create a “shopping list” of used parts that can be searched, located, and procured to reduce the total cost of parts already listed in this estimate.

This process entails intelligent cross-referencing of the OEM parts with used part assemblies that will include those OEM parts, and performing a cost analysis to determine whether or not it would be financially economical to make the switch. For example, if the original estimate contains a door handle as one of the components necessary to carry out a repair of a vehicle, this door handle will be cross-referenced to a used door assembly (since door handles are not generally sold as door handles in the used part world and they come as a part of an entire door assembly, they can only be purchased as such). Therefore, this information is not sufficient to justify searching for an entire door assembly in order to replace a door handle. The current invention has enough intelligence built into its software algorithms to determine whether or not the remaining components of a door assembly are listed in the existing estimate. If it happens that other part components of the door assembly are not listed, the system performs a price comparison of the item that was listed and the door assembly that was matched, if the price difference is sufficient to do a substitution, a door assembly will be replaced with the existing OEM part, otherwise that OEM component of the door assembly will remain as is in the estimate. Of course, such OEM part to used part correlation can be configured according to parameters other than number of estimate parts and price as desired.

It is important to note that the present embodiment of the current invention is capable of cross-referencing OEM or aftermarket part types that are received in any electronic format. Other embodiments can easily be adapted to apply the same algorithms to electronic estimates that are received through e-mail, an XML interface, through FTP, or File Transfer Protocol, or a direct upload to the web site of the company hosting the current invention. The current invention has no requirements as to the format of the repair estimates it receives, but it happens to be using the most common format at the time of this writing which is CIECA's EMS format.

The overall supporting architecture behind the current invention (FIG. 1, Parts Services Layer, 116) is composed of a number of different databases, web servers, and other software assets that enable the current invention to operate. Although the current invention can be fully operational under other similar architectures, it's current embodiment has been created using the architecture described in FIG. 1, and further described in the following paragraphs and related drawings.

The current invention is capable of receiving repair estimates 104, (a sample repair estimate is depicted in “Sample Repair Estimate—FIG. 10”) which are created by estimating software users, and electronically transferred through the Internet to an electronic storage medium accessible by the current invention. These repair estimates can be transferred to the current invention through either a collection program such as the one depicted in 102, EMSCollector, or any other means, 106, such as an XML file submission, e-mail, File Transfer Protocol, direct upload, or even a Fax format that can be converted into an electronic form through OCR (Optical Character Recognition) or other methods.

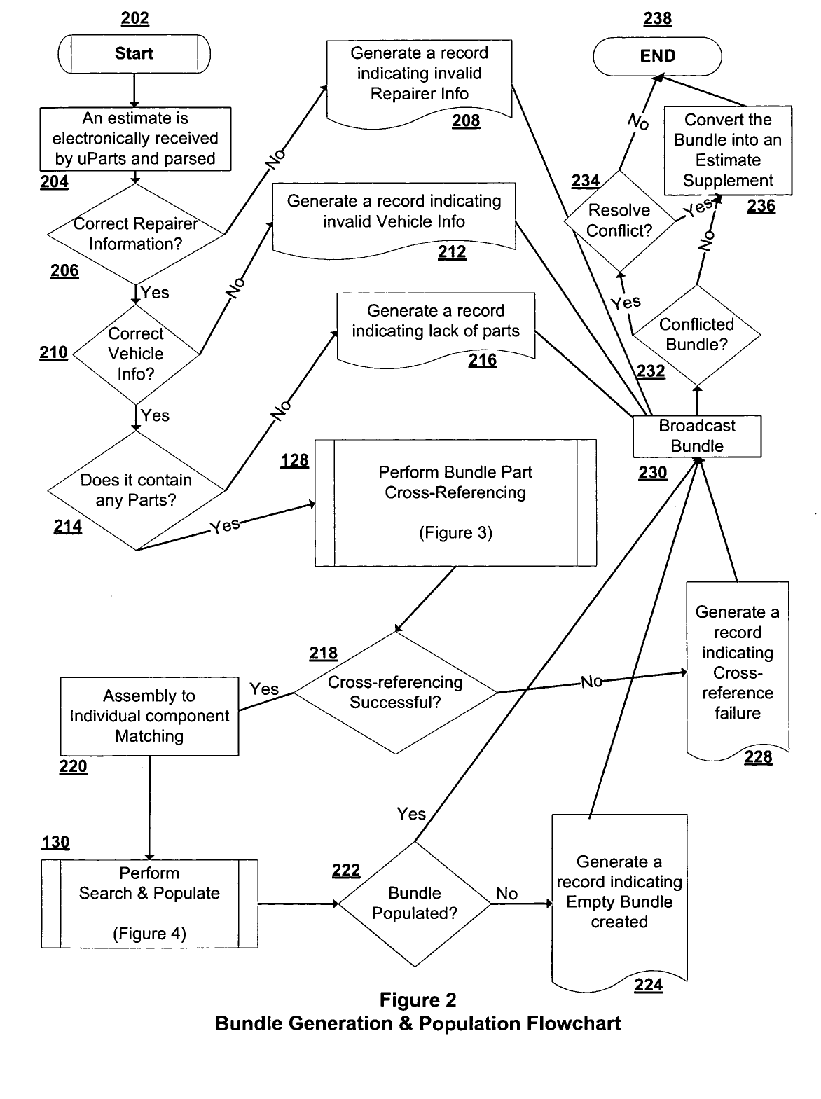

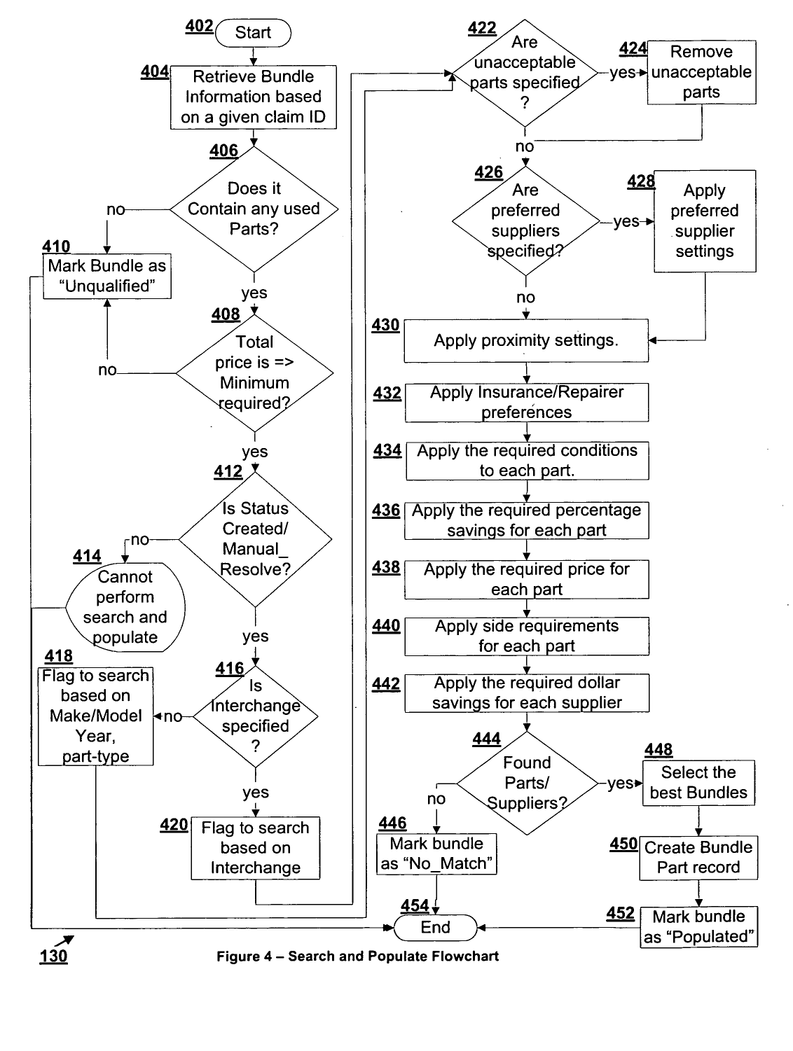

Once these electronic repair estimates are received by the listener module, 108, they are passed on to the Business Logic Layer Services 110, which will in turn utilize the Data Access Layer Services, 112, to obtain the data, and apply the various algorithms and business procedures such as “Bundle Part Cross-referencing—FIG. 3” and “Search And Populate Service—FIG. 4” to electronically cross-reference all of the parts listed within those repair estimates to that of their equivalent used-part numbers. Please note that FIG. 3, and FIG. 4, are more generally described by “Bundle Generation & Population Flowchart—FIG. 2”. If there are any material conflicts or failures in the cross-referencing process, the current invention raises the proper flags for human operators, 118, to try to resolve those conflicts by manual intervention of those Conflict Resolution operators, 118. If any of these operators have previously resolved those exact same conflicts, the current invention, draws upon those “previous resolutions” to automatically resolve the issue prior to flagging it for operator intervention.

Subsequent to the cross-referencing process done in the “Bundle Part Cross-referencing Operation—FIG. 3”, 128, the current invention attempts to populate the used part numbers specified in the Bundle, with actual used parts from various used parts databases, 122, using it's “Search and Populate Service—FIG. 4”, 130, by first applying any insurance company settings and preferences, 120, to the search process, and then systematically identifying used parts with up-to-date data from various database aggregators, 124, which retrieve data from automobile recyclers and utilize DTS, (Data Transformation Services) to keep their database up-to-date. This used parts data can alternatively be obtained from other data sources that may be available to the current invention such as a live query system that queries recycled parts data directly from recycler's Inventory Management Systems. The interactions comprise receipt of the bundle, adding used parts, removing used parts, changing, price information, shipping information, attaching of used parts images, other actions related to receipt and procurement of the bundle, or any combination thereof.

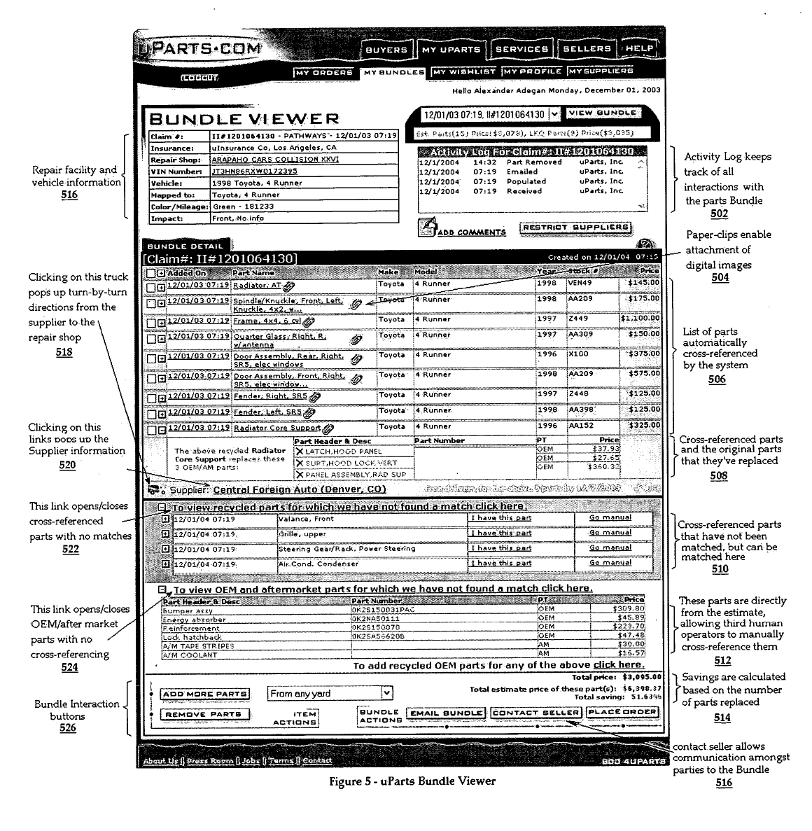

Ultimately the current invention will produce a complete list of parts known as a “Bundle of parts” Depicted in the “Bundle Viewer—FIG. 5” and using the “Bundle Broadcast Services” 114, and Business Logic Layer Services, 110, broadcasts this list (or Bundle), 132, to designated recipients who can use it to procure used and/or aftermarket automobile parts that serve as replacements for the more expensive OEM or aftermarket parts that were originally listed in a given repair estimate. Please note that the current invention will generally replace OEM or aftermarket parts with their equivalent used parts, but another embodiment of the present invention, can, in absence of suitable used parts, replace OEM parts with their less expensive aftermarket equivalents, and present such replacement suggestion in the same Bundle of parts as depicted in “Bundle Viewer—FIG. 5”. Once a bundle is generated and broadcasted (e.g., email, communicated), the system keeps tracks of, and logs all interactions of all recipients of the bundle for accountability, via a unique identifier in the bundle.

The current invention can generate a supplement, 126, to the original estimate. Supplements are similar to original estimates, but contain “supplemental” information for a given repair. For example, a repair estimate that was originally written with 7 parts, may receive an estimate that contains an additional 4 parts, bringing the total number of parts in that repair estimate to 11 parts. The advantage of these estimate supplements lies in their ability to be easily incorporated into the original repair estimates. The current invention can easily convert a Bundle of parts produced as a result of its “Bundle Part Cross-referencing—FIG. 3” and “Bundle Search and Populate—FIG. 4” to a supplement in the original estimating system's format, suitable for amendment of the parts in the Bundle directly to the repair estimate for which these parts were produced.

Supplements are a common feature of all current estimating systems. They allow an insurance adjuster, or appraiser to submit additions, or “supplements” to existing repair estimates (that were created earlier) such that these supplements can be directly reflected in the original repair estimate. This feature of the current invention is capable of creating estimate supplements (that can be directly incorporated into the original estimate) from it's generated parts Bundles, thus facilitating the incorporation of the parts chosen by the current invention into that of an existing repair estimate.

The following paragraphs will describe in detail the methods, business processes, and algorithms that are used by the current invention to carry out its tasks of systematic, accurate and cost-effective identification of used auto parts for a given repair estimate, followed by generation, and broadcast of a Bundle of parts, and/or a repair estimate supplement to any of the designated parties.

The “Bundle Generation & Population Operation—FIG. 2” provides an overview of the series of actions undertaken when an electronic estimate, 104, is received by the infrastructure housing the current invention, 116. As soon as the current invention receives an electronic estimate, 104, it will parse it to its line-item components, 204, namely parts, labor and entries specified in each record of the repair estimate, 104. The estimate, in its correct form, will contain the repair shop's contact information. The current invention will check for the existence of valid repair shop information 206, and validate the entries such as zip code, e-mail address, phone number, etc. If any of the required repair shop information is missing or invalid, the current invention will generate an “Invalid Bundle”, record the cause of the failure 208, and broadcast the Bundle, 230, to party or parties responsible for either conflict resolution, 234, if the Bundle did not produce any parts, or had any invalid vehicle, repair shop, or other information. Otherwise, if the Bundle does not have any conflicts, 232, it will be broadcasted to all designated parties. A copy of the Bundle will also be converted into an estimating system supplement 236, and forwarded to the repair shop for easy inclusion in the original repair estimate for which the Bundle was generated.

The next item that is checked by the “Bundle Generation & Population Process—FIG. 2”, is whether or not the repair estimate, 104, had the correct vehicle information, 210, does it contain any parts, 214 (since some estimates such as a paint job only, repair of the given part, etc. do not require any parts), in each case if the answer is negative, a record is generated indicating the outcome, 216, or 212, and the Bundle is then broadcast, 230, to the parties either for further investigation or resolution of it's conflicts, 234.

If no conflicts are detected, at 206, or at 210, then at 214, the algorithm checks for existence of parts, and if there exists at least at least one part, the algorithm invokes the next operation of the “Bundle Part Cross-Referencing—FIG. 3”. If the cross-referencing is unsuccessful, 218, once again, a record is generated as such 228, and an “Invalid Bundle” is broadcast to that effect, 230, or directed to the conflict resolution operators, 234, for further investigation. Otherwise, the algorithm will proceed to analysis of the Assembly to Individual Component Matching, 220. This process utilizes an Assembly/Components database and is further described in “Bundle Part Cross-referencing with Hollander Interchange Number—FIG. 3B”, 380.

Once all the assemblies have been properly configured, the “Bundle Search and Populate operation—FIG. 4”, 130, is invoked. Subsequent to the “Bundle Search and Populate operation—FIG. 4”, the current invention will check to see if the Bundle was populated, 222. If the Bundle was not populated, the current invention will generate a record indicating the reasons why the Bundle was not successfully populated, 224, and broadcasts the Bundle for Conflict Resolution. If the Bundle was successfully populated, the current invention will create an “estimating supplement”, 236, and forward that “estimate supplement” along with the Bundle to the designated parties, and/or have a unique link representing the Bundle embedded in the estimating software's interface.

This section attempts to further describe the algorithms pertaining to accurate and systematic identification of used parts and HOLLANDER INTERCHANGE NUMBERS that would be best suited to replace a corresponding OEM or aftermarket part within a repair estimate. More specifically this section explains the algorithms involving “Part Cross-Referencing and Matching against HOLLANDER INTERCHANGE NUMBERS” FIG. 3 (A, B & C). Once an electronic repair estimate is received and properly cataloged within the databases of the current invention, the “Part Cross-Referencing and Matching against Hollander Interchange” FIG. 3 (A, B & C) algorithms of the current invention will begin to check for various other elements within the part line-item, and the repair estimate.

In “Bundle Part Cross-Referencing—FIG. 3A”, prior to the initial analysis, the current invention checks, 301, its “OEM/AM to Part-Type-Interchange DB”, 307, to see if the OEM/aftermarket part number supplied in the current invention matches that of a unique HOLLANDER INTERCHANGE NUMBER. This being the case means the current invention has previously cataloged this particular combination in the “OEM/AM to Part-Type-Interchange DB”, 307, and can rely on it's previous work in order to determine the correct cross-referencing for the current OEM or aftermarket part. If the supplied OEM/AM part number lookup fails 301, indicating that the current invention has not previously processed the supplied OEM/AM part number, the algorithm will begin the cross-referencing process.

During the cross-referencing operation, the current invention uniquely identifies the AM/OEM part numbers as they are specified in the repair estimate, and then cross-references them to that of the unique part type, and HOLLANDER INTERCHANGE NUMBER supplied by ADP-HOLLANDER, 377. This aspect of the current invention allows the operator of the current invention to gradually accumulate a comprehensive database of OEM/AM part numbers that have been properly cross-referenced to Part-type and INTERCHANGE NUMBERS, 307, over time, by either the current inventions algorithms, or by human operators that have intervened when the current invention was incapable of producing a proper cross-referencing. This aspect of the current invention keeps track of all matches (whether by operators or algorithmic) and uses them in future searches. This self-learning behavior of the current invention is known as artificial intelligence in the computer world, and enables the current invention to take advantage of its past operations to improve its future performance, since the system inherently learns from its past behavior and becomes smarter through time.

The first step to the cross-referencing process of the current invention begins with suppression of all non-printable characters, 302, to facilitate further examination of the content of each line-item in the repair estimate. Then, the current invention, using a “Non-part info database”, 306, (containing a list of all non part line-items) will further suppress and eliminate the line items that are not relevant to part identification or procurement. Examples of these non-part line-items include: PAINT, TOWING, HAZARDOUS MATERIAL, WASTE, ETC, 304.

The current invention then takes the values of the part line-item, and using “regular expressions” (a computational technique used to effectively parse keywords and divide a sentence into its relevant components), parses these fields into their components 308, in order to construct comprehensible keywords for the current invention through the help of Header Information database, 332. Essentially the values from the free-text fields (entered manually by human operators), or in some cases selected values by these operators, are converted into keywords expected by the current invention.

For example a line-item in a repair estimate that contains in the value, “HNDL, FRT DR, LT” the words “HNDL, FRT DR” are parsed out into their components FRT DR HNDL. The current invention will then properly match these keywords to an existing database of estimate line-item keywords (such as FRT, DR, ASSY, FRNT, which are matched against their proper keywords such as: FRONT, DOOR, ASSEMBLY, FRONT) to determine that they represent a FRONT DOOR HANDLE, which needs to be properly cross-referenced to the recycled part type for a FRONT DOOR HANDLE.

The current invention will then properly identify the correct impact information from the repair estimate 310. Body shop personnel and adjustors create estimates differently. Some estimates have “point of impact” information, while others don't. Similarly some adjustors include the side information in the line item description. For example, keywords such as the “LT” specifies that the FRONT DOOR HANDLE in the above example, is a Front Door Handle on the Left Side as opposed to a right side, or the rear door handle. The current invention takes into account all these variances of side impact specifications, in order to determine the correct side (if side specific) for the part that is listed in the estimate line-item.

The current invention will then attempt to see whether or not the part in the estimate line-item has an equivalent in the used-parts world, 312. Since not all part types can be acquired as used-parts (e.g. Paint, cannot be acquired as used). These type of parts are cataloged as part types with no-used-part equivalent, 314, adding a reference to the Estimate line item, 340, indicating that this estimate line-item is invalid, and then terminating the algorithm, while indicating that given OEM/AM part type in the estimate line-item could not be cross-referenced to any used parts.

However, if the part in the estimate line-item has a used-part type equivalent, that part type is chosen, and the new entry for that line-item, 318, is added to the OEM/AM part list 320, 322 (only if the line-item entry is a new entry, and was not previously added). Otherwise, the used part-type can be looked up, 324, by utilizing the existing part-type, 326, cross-referencing database that is compiled by the operators of the current invention. The following operation checks to see if a match was made 328, using the parsed keywords from the estimate line-item, the type of the estimating software, and the part cross-referencing database, 326. If no matches were made, the algorithm will proceed to check the HEADER INFORMATION of the line-item supplied in the repair estimate. If given the line-item DESCRIPTION information, and HEADER information, the current invention cannot match any part types to that of their used part-type equivalent, it updates the “Estimate Line Item” database, 314, 316, and marks that line-item entry as an invalid entry, and exits the cross-referencing module, indicating it's failure at properly cross-referencing the part in the given estimate line-item.

However, if either the parsed keywords from the line-item DESCRIPTION, 328, or HEADER fields, 330, have resulted in a match to that of a used part-type, the current invention checks to see if the given used part-type is specified as unacceptable or unwanted, 336 by a pertaining insurance company, or repair shop. This information is provided in the “Insurance Company Search Settings—FIG. 10”, or equivalent search settings for repair shops. The purpose of this list is to identify the used parts that must be excluded from the insurance company's searches, 336. For example certain insurance companies do not allow replacement of new airbags with used airbags. This aspect of the current invention applies the list belonging to the specific insurance company (or repair shop) to the cross-referencing operation, making sure that those parts are EXCLUDED from the search, and thus the resulting Bundle of parts.

If the part-type is not listed in the unwanted/unacceptable list of used-parts, the current invention will update the estimate line-item, and cross-reference it to the specific used-part 338, 340. It will then proceed to the next operation: “Bundle Part Cross-referencing with Hollander Interchange Number—FIG. 3B”.

The next set of algorithms in the current invention attempt to find a matching HOLLANDER INTERCHANGE NUMBER for the used part-type that was previously cross-referenced from the estimate line-item during the “Bundle Part Cross-Referencing operation—FIG. 3A”.

During the “Bundle Part Cross-referencing with Hollander Interchange Number—FIG. 3B” operation, the current invention then checks, 342, to see if the part-type was properly cross-referenced during the previous operation. If so, it will attempt to lookup the HOLLANDER INTERCHANGE NUMBER, from the HOLLANDER INTERCHANGE DATABASE, 346, based on the used part-type (e.g. Front Door) make, model, and year of the Vehicle, 344, if no HOLLANDER INTERCHANGE NUMBER is found, 348, the system will attempt to perform a NON-INTERCHANGE query by searching the database of recycled parts using the VIN, make, model, year, and part type information 372. This search does not provide the advantages presented by the HOLLANDER INTERCHANGE NUMBER search, and it yields a limited search result that is not as accurate as the results of a search carried out using the HOLLANDER INTERCHANGE NUMBER. However, since, the HOLLANDER INTERCHANGE NUMBER database lookup did not return any HOLLANDER INTERCHANGE NUMBERS for the lookup in this case, it indicates that there are no HOLLANDER INTERCHANGE NUMBERS for the given VIN, or make, model, year, and part type, and therefore the only option is to proceed with a NON-INTERCHANGE search.

If the HOLLANDER INTERCHANGE NUMBER is looked up based on the make, model, year of the vehicle, and the part-type, the current invention checks to see whether or not there were more than one entries returned by the INTERCHANGE NUMBER lookup, 350. If there is only one entry returned by the INTERCHANGE NUMBER lookup, the system proceeds to select that entry 374, and update the “Estimate line-item database”, 340, and then it proceeds to update the “OEM/AM Number to Part-type-Interchange Number database”, 377, 307, and then in moves to the “creation of assemblies” operation, 378. This operation entails analysis of the “Assembly/Component database”, 380, (“a database that is created by the operators of the current invention, and updated based on interactions of the various parties, including conflict resolution personnel, recycling facilities, or other individuals that interact with the current invention's Bundle of parts). The “Assembly/Component database”, 380, contains information as to which OEM or aftermarket line-item parts can be acquired as part of assemblies of parts in the used-parts world. The purpose of the “creation of assemblies”, 378, operation is to properly group these OEM/aftermarket parts so that they all fall under the used-part assembly that contains all of these OEM/aftermarket parts. This allows the current invention to properly compare the total price of all the individual components of the assembly, with that of the entire assembly prior to making a determination as to whether or not to replace these individual components with their used assembly.

However, if the HOLLANDER INTERCHANGE lookup returns more than one record, it indicates that there were several HOLLANDER INTERCHANGE NUMBERS that matched our query for a given vehicle and part-type (indicating that there are two or more parts that could possibly satisfy the search results for the given vehicle). If there are only two matches, 352, and the system determines that the two INTERCHANGE NUMBERS represent the LEFT and the RIGHT side of the same part, the current invention selects the correct side based on the side information, 354, identified in 310—FIG. 3A, and proceeds to the logging and completion of the cross-referencing operations, 374, 340, and so on, as described in paragraph 0059.

On the other hand, if there are more than two HOLLANDER INTERCHANGE NUMBER entries returned, 352, the current invention performs a begins analyses of the HOLLANDER INTERCHANGE DESCRIPTION field, 356, to determine if there are any other information that would help ascertain the correct HOLLANDER INTERCHANGE NUMBER. For example, the HOLLANDER INTERCHANGE DESCRIPTION field often contains related information from the VIN number of the vehicle. A likely value would be A 1998 Honda Accord, which has several different engine types: one engine type for the DX sub-model can be determined by looking at the 6th digit of the vehicle's VIN number. Depending on what number is shown in the 6th digit of the VIN, the current invention will choose a different HOLLANDER INTERCHANGE NUMBER and carries out its cross-referencing. For example, if the 6th digit of the VIN contains the number 8, the vehicle under repair needs a 2.3 Liter engine, with 4 cylinders but if the 6th digit contains a “1” or a “2” then the 6 cylinder 3.0 Liter engine is the correct part (e.g. indicating to the current operation to select the HOLLANDER INTERCHANGE NUMBER corresponding to the 6 cylinder 3.0 Liter engine). These various specifications are ascertained out of the HOLLANDER INTERCHANGE DESCRIPTION field (by effectively parsing and analyzing the information in that field) and reflected in the current invention. If at this point, the current invention is able to determine the correct HOLLANDER INTERCHANGE NUMBER, it will proceed to the next step of selecting the correct HOLLANDER INTERCHANGE NUMBER and updating the estimate line-item, 374, 340, and so on as described in paragraph 0059.

Otherwise, when the entry is not found, 360, the current operation takes yet another approach to determine the correct HOLLANDER INTERCHANGE NUMBER for the current OEM or aftermarket part in the repair estimate line-item. The current invention attempts to properly match the keywords in the DESCRIPTION field of the estimate line-item with that of the HOLLANDER INTERCHANGE DESCRIPTION field, or to match the keywords from the HOLLANDER INTERCHANGE DESCRIPTION field with that of the keywords provided in the DESCRIPTION field of the current line-item from the estimate, 362.

The DESCRIPTION fields of the repair estimate often contain additional information in the form of free-text in the line-item describing the part type that needs to be replaced. Some form of these options (or free-text descriptions) are sometimes specified in the HOLLANDER INTERCHANGE DESCRIPTION fields provided by the HOLLANDER INTERCHANGE PART NUMBERING SYSTEM for used auto parts. There are currently no automated means for cross-referencing of this free-text information with that of the options specified in the HOLLANDER INTERCHANGE DESCRIPTION fields for further identification of a given used part-type. The multiple approach to systematic part identification employed by the current invention takes into consideration this free-text information and attempts to cross-reference it with that of the HOLLANDER INTERCHANGE DESCRIPTION, and therefore to that of it's corresponding HOLLANDER INTERCHANGE NUMBER that needs to be utilized to identify the correct used part for a given OEM and/or aftermarket part specified in the repair estimate's line-item.

For example: a 1995 Pontiac Firebird has two types of Tail-Lamps one with a Plain Lens, and one with a Checkered Lens. The estimator who wrote the estimate may have specified the words “CLEAR LENS” in the line-item for the Tail Lamp that needed to be replaced for a given vehicle. The current invention takes the words “CLEAR and LENS” and determines that they are referring to the keywords “PLAIN LENS” in the HOLLANDER DESCRIPTION field (or DETAILED DESCRIPTION field). This is done by properly cross-referencing the words CLEAR and PLAIN to mean the same thing, and by mapping the word LENS to that of the word LENS in the HOLLANDER INTERCHANGE DESCRIPTION field. This enables the current invention to specify and search for the correct Tail Lamp, namely the one “DESCRIBED” to have “PLAIN LENS” as opposed to the “DESCRIBED” to have a “CHECKERED LENS”. This algorithmic matching along with a multitude of other methods utilized by the current invention enable the automatic and accurate cross-referencing and matching of OEM and aftermarket parts to that of their equivalent used parts number, and especially to that of the HOLLANDER INTERCHANGE NUMBERS. If at this point, the algorithm determines the correct HOLLANDER INTERCHANGE NUMBER, 366, it proceeds to the logging and completion of the cross-referencing process, 374 as described in paragraph 0059.

Otherwise, the current invention takes yet another approach to accurately identifying the correct HOLLANDER INTERCHANGE NUMBER for the given part in the repair estimate's line-item. This approach entails evaluation of the last 6 digits of the vehicle's VIN number (as described in paragraphs 0024, and 0025) to ascertain the proper HOLLANDER INTERCHANGE NUMBER. This is done by taking into account the last 6 digits of the repair vehicles' VIN number and finding the closest serial numbers of vehicles with the same first 11 digits of the VIN number. These vehicles are queried out of the actual Part Inventory Database, 122, and the HOLLANDER INTERCHANGE NUMBER for part-types of vehicles with the closest serial number (i.e. the last 6 digits of the VIN number) is selected as the most likely match for the part specified in the line item of the repair vehicle. If as a result of this analysis, 370, the correct HOLLANDER INTERCHANGE NUMBER is found, the current invention proceeds to the logging and completion of the cross-referencing operations, as described in paragraph 0059.

Otherwise, the current invention proceeds to the operation of performing a “VIN to Interchange Number Lookup—FIG. 3C” using the available used auto parts database (this algorithm will be described further under the FIG. 3C). If the current invention determines the correct HOLLANDER INTERCHANGE NUMBER, 373, as a result of the operation in FIG. 3C, it will proceed to select that HOLLANDER INTERCHANGE NUMBER, and log the estimate line-item, 374, in the Estimate line-item database, 340, for future reference.

Once this information is logged by the current invention, it checks to see whether or not an OEM or an aftermarket part number exist in the line-item of the current part. If this number exists, the current invention will proceed to update the “OEM/AM part-type-interchange database”, 377, 307. This is done for future references by the “Bundle Part Cross-referencing operation—FIG. 3A”, 301. This “OEM/AM to Part-type-Interchange Number” data accumulation represents one aspect of the “artificial intelligence” employed by the current invention granting it the ability to learn from of all of the prior “OEM/AM to part-type-Interchange Number” cross-references and utilizing them in the future. This makes the current invention more efficient in cross-referencing a great majority of used-part types and their HOLLANDER INTERCHANGE NUMBERS, as this data is accumulated over time. For example, if as a result of this algorithm OEM part number 12345679 is cross referenced to a HOLLANDER INTERCHANGE NUMBER 444333222, this database will log this information, and any future repair estimates that contain the OEM part number 12345679, will immediately be cross-referenced to HOLLANDER INTERCHANGE NUMBER 444333222 regardless of whether or not the corresponding line-item includes any HEADER information, DESCRIPTION information, or other required information necessary for successful cross-referencing.

Finally, the current invention attempts to properly correlate each part type to that of it's containing assemblies. This Create Assemblies operation, 378, takes each part-type, and using a database of Assembly/Component matches (compiled by the operators of the current invention), determines whether or not a part-type, and its corresponding HOLLANDER INTERCHANGE NUMBER should be part of a larger group of parts, known as a used-assembly, or they should be listed individually.

For example, if a given repair estimate requires repair of a Door, different components of that door will likely be listed as OEM and/or aftermarket parts under separate line-items in that repair estimate. Examples of OEM and/or aftermarket line-items for a given door are: “Door Regulator”, “Door Shell”, “Door Handle”, “Door Glass”, etc. These parts are not generally sold in the used part world, but are sold all together as what is known as “an assembly”, in this case a “Door Assembly”. Other examples of assemblies in the used-part industry are “Engine Assembly”, “Headlight Assembly”, “Transmission Assembly”, “Bumper Assembly”, “Front End Assembly”, etc.

So, if a given OEM or aftermarket part type is cross-referenced to a used-part that is listed as a part of a larger assembly, the current invention creates a “one part” to “many” correlation, allowing the “Bundle Search and Populate—FIG. 4”, procedure of the current invention to search for the correct part type which is the “part assembly” as opposed to each individual component of that assembly. Grouping part components (i.e. parts of larger assemblies) together enables the “Bundle Search and Populate—FIG. 4” of the current invention to better compare the different parts of the OEM/aftermarket world with that of their used part equivalents. For example, if there are 5 parts listed in a repair estimate, and all of these 5 parts are part of a single used part assembly, the current invention, will properly compare the total price of the 5 OEM/AM parts to that of their 1 used assembly in order to make a determination as to whether or not replace the 5 parts with that of their 1 used assembly.

One of the main tasks of the current invention lies in its ability to correctly identify a HOLLANDER INTERCHANGE NUMBER for a given part type, make, model and vehicle year. As discussed earlier, this is a difficult task that, up until now, has been accomplished ONLY by human operators who are intimately familiar with the part numbering systems and nomenclature of the OEM, aftermarket, and used automobile parts. These operators utilize their knowledge in order to correctly select the correct part-type for a given line-item in a repair estimate. The current invention addresses this problem from several different fronts as discussed above. However, one aspect (VIN to Interchange Number Lookup using parts database, FIG. 3C) of the current invention relies on the knowledge of thousands of automobile recyclers (i.e. used parts suppliers) who have dismantled millions of used auto parts and have catalogued them in their Inventory Management Systems.

Taking advantage of these individuals' knowledge and expertise does NOT mean that they are required to be present during the operation of the current invention. Using the algorithm described in FIG. 3C, the current invention extrapolates the correct HOLLANDER INTERCHANGE NUMBER, from the millions of used auto part records that are stored in the used parts databases managed by the operator of the current invention, and aggregated from the Inventory Management Systems of thousand of automobile recyclers (used part suppliers). “VIN to Interchange Number Lookup using Parts Database—FIG. 3C” describes the algorithms through which the current invention carries out this extrapolation, and hence intrinsically takes advantage of the knowledge that these individuals have embedded in millions of used auto parts records in their collective Inventory Management Systems.

When the current invention is presented with more than two possible part-identifiers or HOLLANDER INTERCHANGE NUMBERS as described in “Bundle Part Cross-referencing with Hollander Interchange Number—FIG. 3B”, 352, the current invention invokes the algorithm in “VIN to Interchange Number Lookup using Parts Database—FIG. 3C”. This procedure attempts to ascertain the correct HOLLANDER INTERCHANGE NUMBER by analyzing a massive database of existing used parts, their corresponding VIN numbers, and HOLLANDER INTERCHANGE NUMBERS. These algorithms rely on the VIN numbers (among other things) that were entered by thousands of automobile recyclers in their Inventory Management Systems along with the HOLLANDER INTERCHANGE NUMBERS corresponding to used auto parts that were dismantled from the vehicles and cataloged using those vehicle's VIN numbers.

In order to properly compare the VIN numbers from the current database of used parts, the algorithms in FIG. 3C compose a “Compact VIN” number which consists of the first 8 characters of the VIN+the 10^{th} and the 11^{th} character, 378. This Compacted VIN becomes the key for lookup of the correct HOLLANDER INTERCHANGE NUMBER from an existing database of millions of recycled parts. However, prior to using the database of recycled parts, the current invention checks 380, 382, to see if this compacted VIN number has been previously utilized to identify a correct HOLLANDER INTERCHANGE NUMBER. If so, the algorithm selects the correct HOLLANDER INTERCHANGE NUMBER, and updates the corresponding counter in the “VIN-Interchange Number database”, 386, 382, to reflect this entry was utilized again, and then it terminates the algorithm successfully.

Otherwise, if no match was found 384, in the VIN-Interchange Number database 382, the algorithm attempts to extrapolate a correct HOLLANDER INTERCHANGE NUMBER from the current inventory of millions of used automobile parts, 122, by running a query for all the records that match the Compacted VIN number composed from the VIN number of the vehicle for which the current repair estimate was written, 388. If a match is found, 392, in the Part Inventory Database, 122, the algorithm checks to see if the number of entries found are greater than the minimum threshold defined as the variable X, in 394. This variable can be set by the operators of the current invention. It determines the accuracy of the selection process. Essentially the higher the value of this variable (with a minimum of 1) the more matches have to be made, when the “Part Inventory Database” query is run for the match to be considered accurate. In the present embodiment of the current invention, this variable is set to 3. This means that if at least 3 parts were identified with the same HOLLANDER INTERCHANGE NUMBER for a given Compact VIN query, the current invention determines that the HOLLANDER INTERCHANGE NUMBER for the current used part under consideration (the one from the repair estimate line-item) is the same as the HOLLANDER INTERCHANGE NUMBER that was returned when Compact VIN query was run on the “Part Inventory Database”. This successful match results in insertion of an entry in the “VIN to Interchange Number database”, 396, 382, for future reference, and the successful cross-referencing of the OEM/AM part number to that of it's equivalent HOLLANDER INTERCHANGE NUMBER.

In the above example, this embodiment of the current invention relied on the knowledge of the 3 separate individuals, who dismantled, and cataloged 3 separate parts (using their HOLLANDER INTERCHANGE NUMBER) for 3 separate vehicles and entered the same exact Compact VIN number as the used-part for which the current invention was trying to determine the correct HOLLANDER INTERCHANGE NUMBER. This provides an adequate degree of certainty for the current algorithm to select the same HOLLANDER INTERCHANGE NUMBER for the part-type in the line-item of the current repair estimate.

The algorithms depicted in FIGS. 3 (A, B, & C) were responsible for properly cross-referencing as many of the line-items in the repair estimate to that of their equivalent used part types, and assigning the proper HOLLANDER INTERCHANGE NUMBERS to those items. This processes result in creation of an “empty” Bundle of parts. This means that the part-types and their HOLLANDER INTERCHANGE NUMBERS are defined in a Bundle and are ready to be searched and populated. Now the current invention invokes the “Bundle Search and Populate—FIG. 4” procedure to search and locate the parts specified in the Bundle, and populate the Bundle with those search results.

The “Bundle Search and Populate—FIG. 4”, procedure begins by retrieving the Bundle Information based on a given claim ID, 404, it then checks to see if the Bundle contains any used parts at all, 406. If there are no used parts listed in the Bundle, the Bundle is marked as “Unqualified”, indicating that the repair estimate for which this Bundle was generated does not qualify for a used part search, 410, and then the Search and Populate procedure terminates, 454.

However, if there are one or more parts listed in the Bundle, the current invention checks to see if the total price of the parts listed meet a predefined minimum value, 408. This is done to prevent this process from searching for any parts replacement, if there are not enough parts listed for the current invention to produce a minimum required savings. For example, if the current invention is trying to produce $100 in savings, and the total dollar value of parts currently listed in the repair estimate are $80, it would be impossible to produce $100 in savings for that particular repair estimate, and therefore there is no point in continuing with the Search and Populate process. Therefore, once again, the Bundle is marked as unqualified, and the Search and Populate procedure terminates.

If, on the other hand, the total price of the Bundle exceeds the minimum requirement, the current invention checks to see whether or not the status of the Bundle is in the “Created” or “Manual_Resolve” states, 412. If the status of the Bundle is not in any of these two states, the Search and Populate algorithm will once again terminate raising an exception 414, as to why the Search and Populate algorithm could not carry out the search process. If the Bundle status is in one of the “Created”, or “Manual_Resolve” states, it indicates that the Bundle has either been successfully created by the “Bundle Part cross referencing operation—FIG. 3” operation, or it has been modified by a human operator and it is ready to be searched with the status of “Manual_Resolve”.

At this point, the current invention checks to see if there are any HOLLANDER INTERCHANGE NUMBERS specified for any of the given parts, 416. If there are, the Search and Populate algorithm is flagged to perform an INTERCHANGE-BASED (i.e. a query using the HOLLANDER INTERCHANGE NUMBER) search, 420, otherwise, the algorithm will be flagged to perform a NON-INTERCHANGE (i.e. a query using only the vehicle's VIN, or make, model, year, and part-type information) search, 418. Prior to the beginning of the search process (either INTERCHANGE-BASED, or NON-INTERCHANGE) the current invention examines the unacceptable-parts list, 422, supplied by the insurance company, or repair facility for which this Bundle is being processed. If the entries match any of the parts in the unacceptable-parts-list, they are removed, 424, in during this operation of the algorithm.

Then, the current invention checks for any preferred supplier settings, 426, supplied by either the insurance company, or the repair facility for which this Bundle is being generated. Once the preferred supplier settings have been applied, 428, the current invention applies any “proximity settings” that may have existed for the given Bundle, 430. For example some insurance companies specify that the parts located for their repairs cannot be farther than 175 miles from the repair facility. These settings are applied during this operation, 430, of the Search and Populate procedure.

Subsequent to application of the proximity settings, the Search and Populate algorithm applies any other preferences that are specified by either the insurance company, or the repair facility, 432. This operation further filters out the search results according to the insurance company's or repair facilities preferences in terms of warranty, freshness of the data, percentage of savings produced on the parts, and rating of the supplier.

The following step in the Search and Populate algorithm, applies the required condition codes to each part, 434. This operation takes advantage of a large database of keywords that are specified as keywords that are “unacceptable” by insurance companies. (This should not be confused with “unacceptable parts” which are used part types that the insurance company does not accept). Conditions of used parts are extremely important for insurance companies. They often specify that parts that are furnished for their repairs must be of “insurance quality” or they will not be accepted. The Search and Populate algorithm addresses this problem by applying filters for keywords such as: BROKEN, BURNT, DAMAGED, etc., to the list of qualifying recycled parts for a particular search, excluding them from the search results. This provides additional assurances as to the quality of the requested parts returned by the “Search and Populate algorithm”.

Another effective method for increasing the efficacy of the Search and Populate algorithm removes the qualifying parts from the search results by filtering out part prices that are deemed either too high (i.e. their price is too close, or is above the price of the OEM or aftermarket part, or group of parts in case of assemblies), 436, or they are too low, i.e. don't meet the “Minimum Inventory Price”, allowable for that used-part type, 438. The algorithm then proceeds to apply side requirements to each part, 440, eliminating parts that have the wrong side in the search results. For example, in some cases the side information cannot be directly derived from the HOLLANDER INTERCHANGE NUMBER. In these cases, the side information has been derived by the “Bundle Part Cross-referencing FIG. 3A”, operation, 310. For example, if a Left side Fender is specified in the search criteria of the Bundle, and the search result includes, both Left and Right side Bumpers, the Right side Bumpers are eliminated.

At this point, the current algorithm has likely produced search results from a multitude of suppliers. The algorithm then applies a filter to the Bundle, based on the “Minimum Dollar Savings” requirement, 442, for each Bundle and it's underlying repair estimate. This variable aids the current invention in producing Bundles that have a minimum required savings. The present embodiment of the current invention, has the minimum savings value set to $100. In other words, if the current invention is not capable of producing at least $100 in savings for a given repair estimate, it will not produce a populated Bundle, and it will raise an exception alert to that effect.

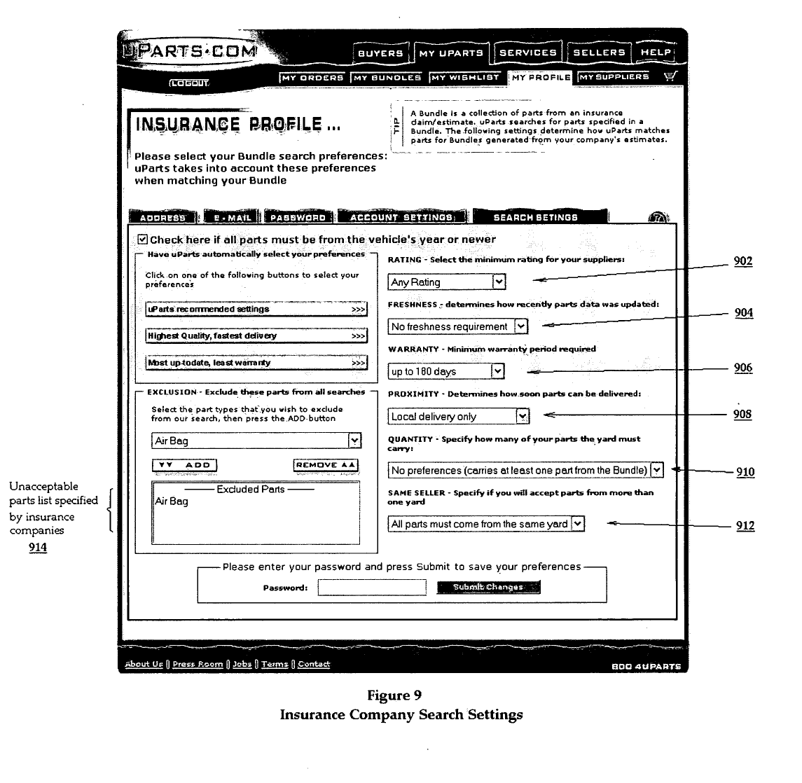

Once all the applicable filters have been applied, the Search and Populate algorithm checks to see if the results set still contains qualifying parts and suppliers, 444. If this is not the case the Bundle is marked as a No_Match Bundle, 446, indicating that the Search and Populate procedure could not locate any suitable parts for the underlying repair estimate. Otherwise, the current invention will select either one, two, or three suppliers depending on the Bundle's insurance company's search settings as depicted in “Insurance Company Search Settings—FIG. 9”. The algorithm will then proceed to find the most suitable Bundles, 448. The most suitable Bundles are chosen based on two weighted criteria: 1) Which Bundles produce the highest dollar savings, and 2) Which Bundles have the closest distance to the repair shop for which the repair estimate was written. The algorithm will then proceed to create all the pertinent Bundle Part Records, 450, and mark the Bundle as “Populated”, 452, and then terminates the Search and Populate procedure, 454.

At this point, the current invention has managed to accurately cross-reference a number of OEM and/or aftermarket parts within a given repair estimate, to that of their corresponding used part types, and HOLLANDER INTERCHANGE NUMBERS, set the criteria for each of those parts in a Bundle of parts, and populate that Bundle with the most suitable collection of parts from one or more suppliers, based predefined preferences and search criteria.

The current invention will then broadcast the generated Bundle to a set of designated recipients, or provide access to this Bundle through a unique URL over the Internet. The Bundle can be viewed using a Graphical User Interface of the current invention using a Web Browser, through the Bundle Viewer Interface as depicted in “Bundle Viewer—FIG. 5”.

The “Bundle Viewer—FIG. 5”, is composed of a number of different elements that facilitate communication among various parties to the Bundle, while providing the means for these individuals to readily manipulate the entries, e.g. part listings, delivery options, comments, digital images, etc., of the Bundle. “Bundle Viewer—FIG. 5” consists of an “Activity Log” section, 502, that keeps track of all interactions between the various parties to the Bundle. Digital images can easily be attached to each part within the Bundle, 504, by clicking on an image of a paperclip that is visible next to used part entry on the Bundle. A complete list of all the parts that were automatically cross-referenced and populated, 506, is displayed in the main section of the Bundle Viewer. The user can easily click on a + sign next to each entry to learn what OEM and or aftermarket parts are replaced, 508, by each used-part entry, and what are the total prices of these parts compared to the price of the used parts that has replaced them.

One of the most valuable advantages of the current invention, lies in the fact that it not only lists the used parts that were automatically cross-referenced, searched and populated, but also provides an interface allowing the user to view the parts that were cross-referenced, but were not populated, 510, (because a suitable match was not found, or did not meet the search criteria, or other preferences of the parties to the Bundle). This feature enables the user to manually add these parts to the Bundle, and therefore enhance the performance of the current invention by allowing human operators such as Conflict Resolution personnel, 118, to further enhance the Bundle.

The “Bundle Viewer—FIG. 5”, further displays OEM and/or aftermarket parts that were listed in the original estimate, but the current invention was unable to properly cross-reference, 512. This provides another opportunity for Conflict Resolution personnel, 118, to further enhance the Bundle by providing the cross-referencing based on their knowledge of the OEM, aftermarket, and used parts numbering system, and nomenclature. It is of utmost importance to note that all of the actions of these experience Conflict Resolution personnel, or other parties that are allowed to manipulate the Bundle (such as suppliers with extensive knowledge of these parts) are recorded by the current invention in a database, along with time of the action, the person who carried out the action, and a multitude of other attributes, for future references by the current invention. This enables the current invention to take advantage of the collective input of all the operators who come in contact with Bundles throughout the operation of the current invention, by learning from their past behavior in order to improve its future performance.

The “Bundle Viewer—FIG. 5”, also automatically calculates the savings produced through replacement of OEM and aftermarket parts with that of their used equivalent parts, 514. It also provides detailed information about the repair facility and the insurance company responsible for generating the underlying repair estimate, 516, along with vehicle and points of impact of the vehicle. The information for the repair shop can be displayed with a single click on the link corresponding to the repair shop. Furthermore, the VIN number of the vehicle under repair is also visible on the Bundle Viewer. Clicking on that link also displays another window with detail breakdown of the information in the Vehicle Identification Number such as Engine Type, Body Style, Make, Year, Model, Fuel type, etc.

The “Bundle Viewer—FIG. 5” provides a small “truck figure” on the bottom section of the screen, 518. Clicking on this image, 518, will conveniently display a new browser window containing turn-by-turn directions, and distance from the supplier to the address of the repair shop, where parts are to be delivered. This feature allows anyone to retrieve directions from/to the repair shop, in order to facilitate the timely delivery of the parts to their destination. The Bundle Viewer user can also click on the link in front of the Supplier, 520, to popup contact information (such as: address, telephone/fax numbers, e-mail address, etc) about the supplier. A number of links and buttons allow the user to open/close the “unpopulated” but cross-referenced used-parts list, 522, the “unpopulated”, and “non-cross-referenced” section of the OEM/aftermarket parts list 524, or to easily add/remove parts, 526 from/to the Bundle by performing additional searches. Other buttons enable the user to place an order directly from the Bundle Viewer, or to e-mail the Bundle to anyone else with an e-mail address or to contact the seller through several different communications methods.

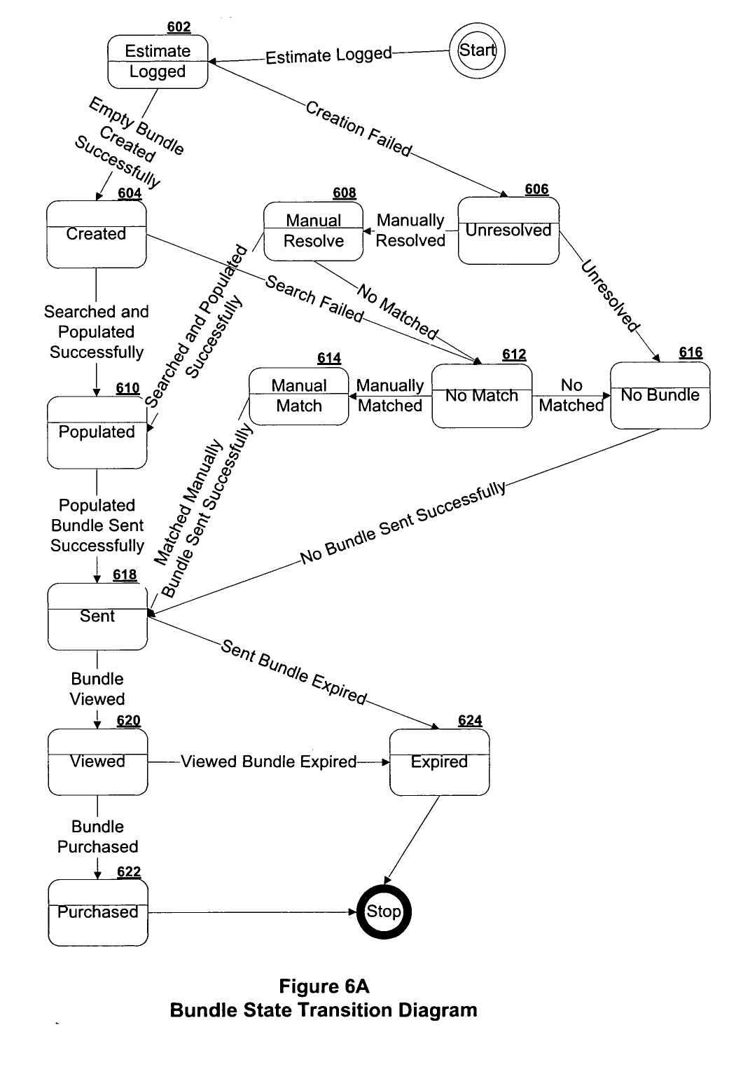

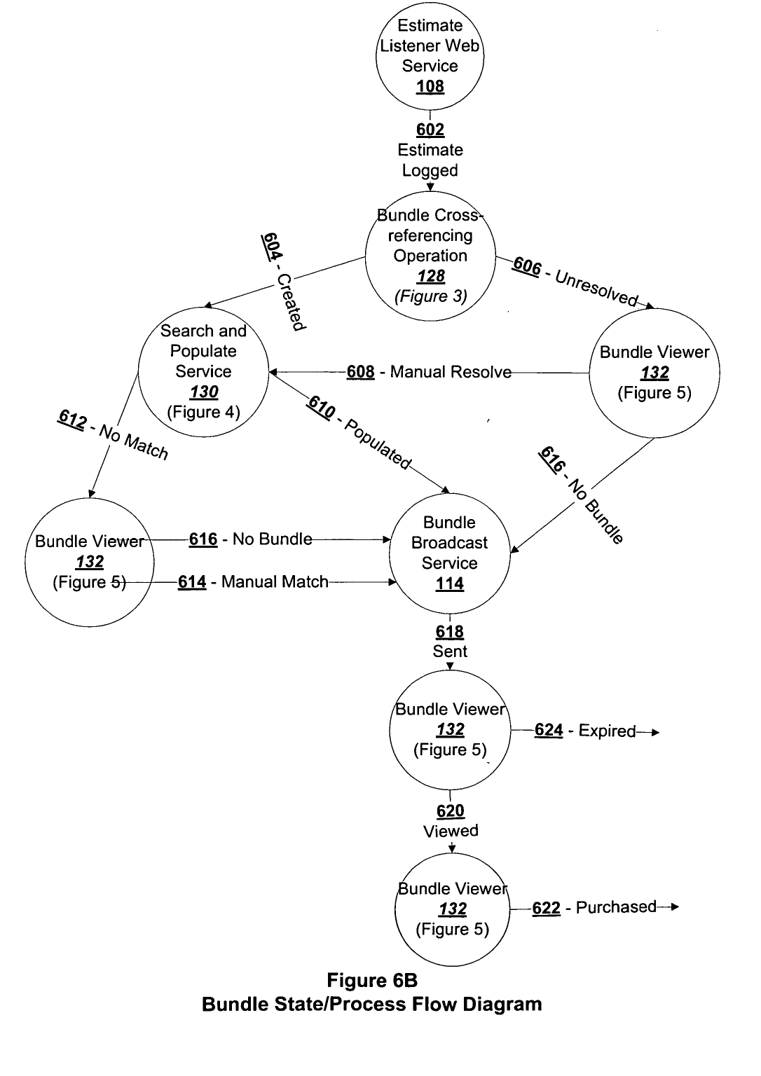

The “Bundle State Transition Diagram—FIG. 6A” depicts the various states that the Bundle goes through during it life, and the transitions that cause these state changes. As soon as an electronic estimate, 104, is received by the infrastructure of the current invention, 116, it is logged, 602, to an estimate database. The current invention then attempts to create a Bundle by properly analyzing each line-item of the electronic repair estimate, 102. If the current invention succeeds in creating the Bundle, the state of the Bundle is transitioned to “Created”, 604, otherwise, the failure of the creation operation will result in the Bundle's state to transition to the “Unresolved” state, 606. The Bundle can now transition to only two other states; it can either transition to a “Manual_Resolve”, 608, state where a Conflict Resolution, 118, operator can manually resolve the Bundle (i.e. determine it's conflict and correct them) or it can transition the “No_Bundle” state, 616, indicating that the current invention was unable to produce a useful Bundle of parts for a given repair estimate.

The “Manual_Resolve”, 608, state can then either transition to the “No_Match” state, 612, indicating that the current invention is unable to find any parts for the Bundle, or it can transition to the “Populated”, 610, state if the manual resolution results in population of the parts in the Bundle. The “No_Match” state, 612, can also transition into the “No_Bundle” state, 616, indicating that the current invention was unable (due to issues that could not be resolved) to produce a Bundle for a given repair estimate. On the other hand, the Bundle can transition from the “Populated”, 610, to the “Sent” state, 618, indicating that the Bundle has been broadcasted to designated parties successfully. The only other way to transition out of the “No_Match”, 612, state is for a Conflict Resolution operator, 118, or another responsible party, to manually match used parts for the given criteria in the Bundle. In this case, the Bundle will transition to the “Sent”, 618, state.

A Bundle that has transitioned to the “Sent” state, 618, can either transition to the “Expired” state, 624, indicating that it was not utilized during it's designated life-time (“a predefined number indicating how many days a Bundle should remain valid), or it can transition to the “Viewed” state, 620, indicating that one or more recipients of the Bundle have viewed the Bundle by clicking on it's corresponding link. A Bundle in the “Viewed” state, 620, can also transition into the “Expired” state, 624, if it is not purchased within a predefined time period). However, the most desired outcome for the Bundle in the “Viewed” state, 620, is to transition to the “Purchased” state, 622, indicating that the Bundle of parts were purchased by the designated recipients. Both “Purchased” state, 622, and “Expired” State, 624, are final states of the Bundle after which the Bundle will stop transitioning to any other states.

FIG. 6B—Bundle State/Process Flow Diagram represents the states and the processes that are applied to a given Bundle as it transitions through the current invention. FIG. 6B is complementary to FIG. 6A, and depicts the state transitions as actions between different processes of the system. It begins with the Estimate Listener Web Services, 108, receiving and logging a repair estimate, 602. This initiates the Bundle Cross-referencing Process, 128, as depicted in detail in FIGS. 3A, B, & C. If the Bundle is successfully created, 604, it transitions to the “Created” state, 604, and then the current invention invokes the Search and Populate Services, 130. Otherwise, if the current invention is unable to resolve the required characteristics of the current Bundle (e.g. VIN number, repair facility, etc.), it will transition to the “Unresolved” state, 606, and make the “Unresolved” Bundle available through the Bundle Viewer, 132.

On the other hand, if a Conflict Resolution operator, 118, resolves the conflicts in the Current Bundle, 608, it will transition to the “Manual Resolve” state, and proceed to the “Search and Populate Service”, 130. From Search and Populate, a Bundle can transition to either the “No_Match” state, 612, and then sent to the “Bundle Viewer, 132, for further manipulation by Conflict Resolution operators, 118. These operators can then either manually match parts for the Bundle, and force it transition to the “Manual_Match” state, 614, or the Bundle will automatically transition to the “No_Bundle”, state, 616, indicating that no parts could be located for the given parts within that Bundle. These states, along with the “Populated”, 610, state will all invoke the “Bundle Broadcast Service”, 114, which will broadcast the Bundle in any of it's states, (long with a description of the exceptions that caused the Bundle to transition into that State), to the various parties, causing it's state to transition to the “Sent” status, 618, Once Bundles are sent, they can once again be viewed in the Bundle Viewer, 132.

If a predefined number of days pass by without anyone purchasing the Bundle, the Bundle will transition into the “Expired” state, 624, indicating that no-one has utilized the Bundle. Otherwise, it can transition to the “Viewed” state, 620, indicating that someone has viewed the Bundle since it was broadcasted, or Sent. Once an individual has viewed a Bundle, he or she can purchase the Bundle, by placing an order for the Bundle directly from the Bundle Viewer, 132, interface, therefore causing its status to transition to the “Purchased” state, 622, if the ordering process is completed.

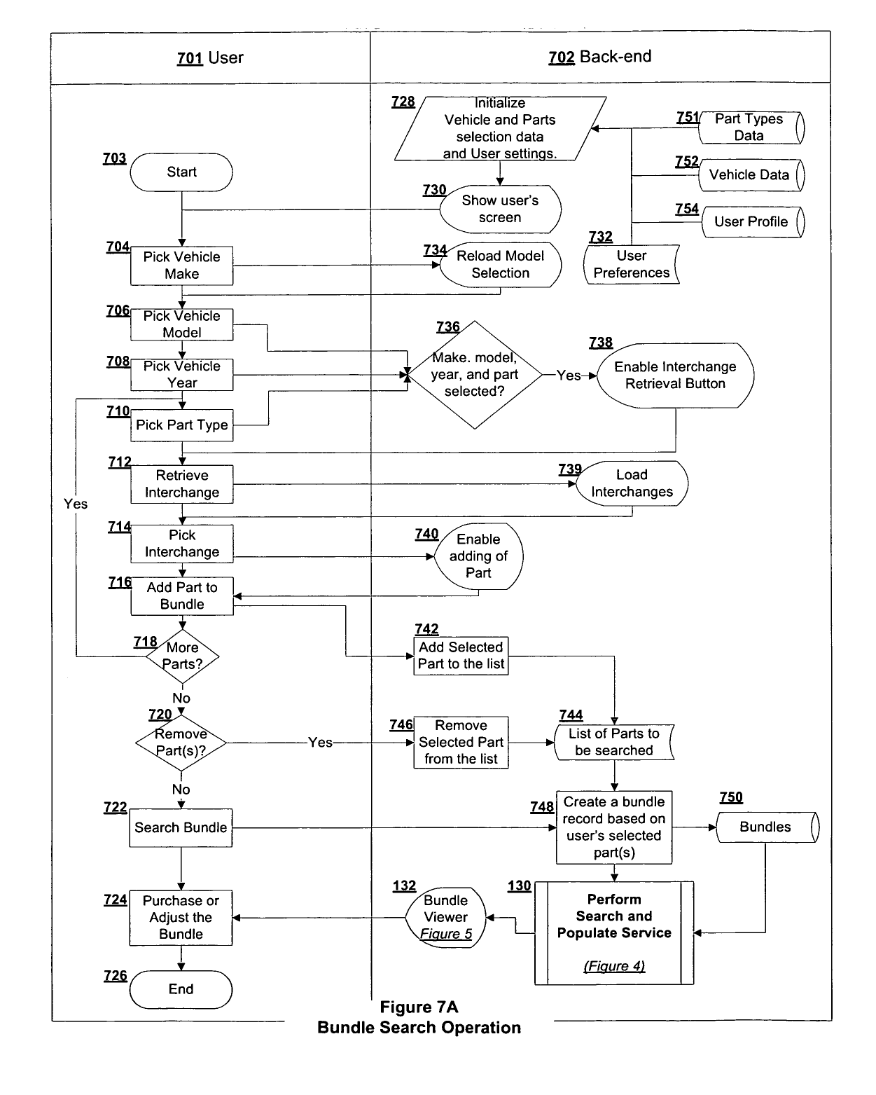

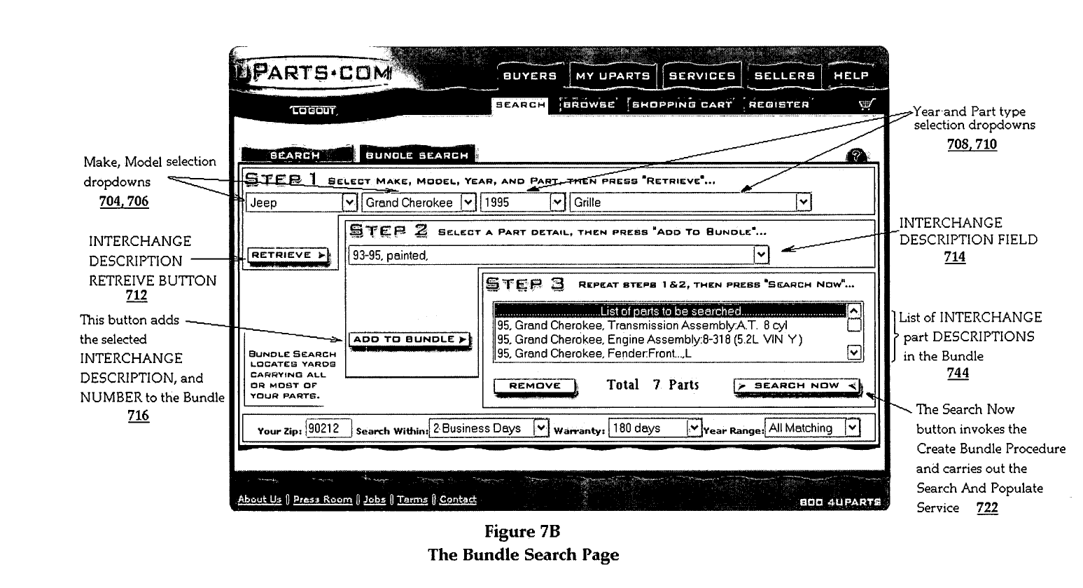

The “Bundle Search Procedure—FIG. 7A”, and the “Bundle Search Page—FIG. 7B” represent another embodiment of the current invention that enables specifications of a number of different used part types, and their HOLLANDER INTERCHANGE DESCRIPTIONS (the HOLLANDER INTERCHANGE NUMBERS are not represented here, but are internally defined through their corresponding HOLLANDER INTERCHANGE DESCRIPTIONS), into a web interface (Bundle Search Page—FIG. 7B), and the procedures that are carried out in order to produce a Bundle for the specified used parts search criteria.

The Bundle Search application is composed of two sections, a user section, 701, and a Back-end section, 702. The “Bundle Search procedure FIG. 7A, begins by initializing, 728, parts, 751, and vehicle, 752, selection data and user preferences, 732, & profiles, 754, within it's back-end section, 702. The web-based user interface “Bundle Search Page—FIG. 7B” will then be displayed to the user, 730, based on his or her preferences (such as zip code, maximum desired delivery radius, etc.)

The first step the user takes is to pick a vehicle make from the selection, 704. This forces the selection, 706, for that particular vehicle's models to be loaded, 734. The next action for the user is to select a vehicle model, 706, and then proceed to select a year, 708. Once the first 3 vehicle characteristics (i.e. make, model & year) are selected, the user proceeds to select the used part type, 710. Although the user can go through these steps in any given order, the present embodiment of the current invention only checks to see if all steps are completed, 736, prior to enabling the button, 712, that allows retrieval of HOLLANDER INTERCHANGE DESCRIPTIONS, 738.

As soon as selections for vehicle make, model, year and part type are completed, the next action for the user is to retrieve the HOLLANDER INTERCHANGE DESCRIPTIONS for the current selections by clicking on the “Retrieve” button, 712. The current invention will then load, 739, the appropriate HOLLANDER INTERCHANGE DESCRIPTIONS into the “DETAILED DESCRIPTION” selection dropdown, 714, also depicted in FIG. 7B.

To proceed, the user can select his or her desired HOLLANDER INTERCHANGE DESCRIPTIONS, from the corresponding dropdown, 714. Selecting a HOLLANDER INTERCHANGE DESCRIPTION, enables, 740, the user to add, 716, 742, (one on the use-interface, and one on the back-end) his or her desired HOLLANDER INTERCHANGE DESCRIPTION, to the Bundle list, 744. As soon as the user indicates his or her desire to add the selected HOLLANDER INTERCHANGE DESCRIPTION to the Bundle, 716, 742, by clicking the “Add to Bundle”, 716, button (also depicted in FIG. 7B), the current invention will add that selection to a list of selected used parts, 744 (also depicted in FIG. 7B). If the user wishes to add more parts, 718, he or she repeat the same set of actions by going back to the part type selection action, 710, and continuing on to the “Add to Bundle”, 716 operation. These operations can be repeated for up-to 75 different parts, thus allowing the user to search for 75 different used parts simultaneously.

The user can also remove one or more parts through this interface, 720. He or she can do this by selecting the part to be removed from the Bundle parts list, 744, and then clicking on the “Remove” button. The current invention will then remove the part, 746, from the Bundle parts list, 744. After adding and removing the desired parts, the user is ready to invoke the “Search and Populate Service, 130, proceeding to the Search Bundle procedure, the user will press the “Search Now” button, 722, which will in turn invoke the “Create Bundle” operation, 748. This operation is similar to the “Bundle Part Cross-referencing procedure”, 128, but does not need to perform any cross-referencing since the parts in this embodiment of the current invention are already being selected as used parts, not OEM or aftermarket parts as was the case in previous embodiments. So, the “Create Bundle” operation, 748, creates an empty Bundle, storing it to Bundles database, 750, and invokes the “Search and Populate Procedure, 130, to locate the proper parts, and populate the Bundle. The user is then presented with the Bundle Viewer, 132, user interface for viewing, manipulation, and possible ordering of the parts in the Bundle. The user can then proceed to Purchase the Bundle, or make adjustments to it, 724, as desired. This terminates the Bundle Search Algorithm, 726.

Both the “Bundle Search and Populate procedure”, 130, and “Bundle Search procedure (depicted in figures FIGS. 7A and 7B), intelligently utilize a “shopping list” of used parts for their search operation, as opposed to searching for one part at a time. This approach solves a common problem in the used parts industry by allowing this “shopping list”, (or our Bundle) to be searched for and located in one shot, therefore finding suppliers that carry as many parts form the Bundle as possible, as opposed to locating one part at a time, which is currently the case for other parts locating systems.

The current invention utilizes a complete Bundle of parts, belonging to one vehicle, to carry out its search. Existing locators of used parts only allow for searches to take place one-at-a-time. This poses many inefficiencies within the repair industry. For example, it is not acceptable to order 5 different parts from 5 different suppliers in this industry. Therefore, if a person searches for each of the 5 parts in a shopping list of used parts, they will be getting a different supplier for each of their searches, and at the end of their search they could end up with 5 different parts from 5 different suppliers. The current invention properly addresses this concern by making sure that the search is performed on the Bundle (as opposed to each individual part) and therefore results are returned from the same supplier, as opposed to several different suppliers. This characteristic of the current invention also produces significant savings for the buyer on the shipment of items, since they will all be shipped from one source and at one time, as opposed to from different sources and at different times.

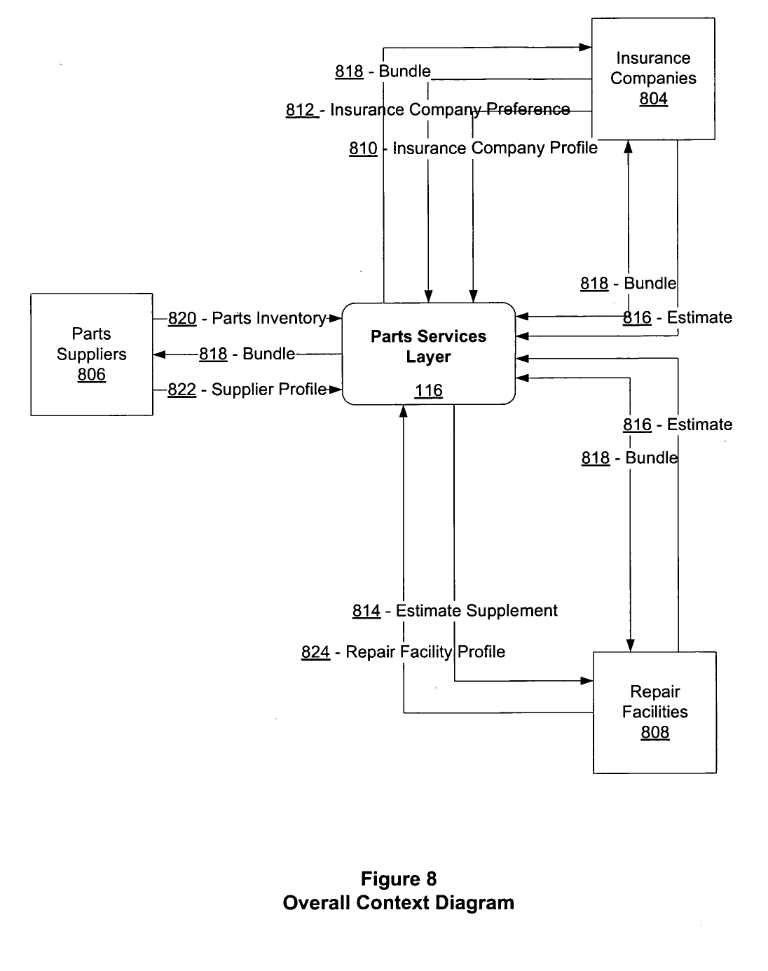

FIG. 8 depicts a diagram of the current invention's overall context. It represents the relationship between the various parties that interact with and take advantage of the outcome of the present invention's operations and what they produce (e.g. a Bundle of parts), as well as the information flow between these parties and the Parts Services Layer, 116. An insurance company, 804, or a repair facility, 808, can submit electronic estimates, 816, to the Parts Services Layer, 116. These are electronic versions of repair estimates similar to what is depicted in FIG. 10—Sample Repair Estimate. The EMS Collector, 102, is generally responsible for submitting these estimates, 816, to the Parts Services Layer, 116. Although the present embodiments of the current invention transmit these estimates in their EMS (described in paragraph 0019) format these repair estimates can be submitted to the infrastructure housing the current invention, 116, through many different methods such as XML, FTP, e-mail, etc., as discussed in paragraph 0033.

If the Parts Services Layer, 116, of the current invention is able to successfully create a Bundle, 818, it will broadcast that Bundle to Parts Suppliers, 806, for possible modifications, and enhancements. Another copy of the Bundle, 818 is forwarded to Insurance Companies, 804, for further analysis, and approval of the parts list, and finally a third copy of the Bundle, 818, is forwarded to the Repair Facility, 808, for final inclusion in the repair estimate (for which the Bundle was generated), and procurement of those parts from the specified suppliers, 806.

Another embodiment of the Bundle that is most useful to repair facilities is the Estimate Supplement, 814. The Parts Services Layer, 116, of the current invention is capable of converting a populated Bundle into that of an electronic repair estimate supplement, 814. These supplements, 814, contain the same part list as the Bundle, 818, with the exception that they are in the same estimating system's format from which the original repair estimate was generated, allowing those parts to be easily incorporated into the repair facility's estimating system.

FIG. 8—The Bundle Context Diagram, also depicts the profiles set up by various parties of the Parts Services Layer, 116, of the current invention. Insurance Companies, provide their profiles, 810, as well as their Insurance Company Preferences, 812, such as warranty, data freshness, proximity settings, etc. to the Parts Services Layer, 116 of the current invention. Repair facilities, 808, also provide their profiles, 824, for proper identification, and authentication, and transfer of their estimates. Finally, parts suppliers, not only provide their supplier profiles, 822, to the current invention's Parts Services Layer, 116, but also provide their tens of thousands of parts inventory records, 820, for consumption by the Part Services Layer, 116, of the current invention.

It is important to note that the current invention employs artificial intelligence to determine the accurate cross-referencing between the OEM/AM parts, and their used equivalents. This is done on two different fronts: 1) Through accumulation of prior cross-referencing of such parts by human operators, 118. If and when a human operator, or Conflict Resolution personnel, 118, makes a determination as to an OEM or an aftermarket part 1234567 being equivalent to a recycled parts 222333444, this reference is saved into a the artificial intelligence database, 307, within the current invention, and is later used to make that same determination algorithmically, whenever the same OEM or aftermarket part is being cross-referenced. In cases where the invention is incapable of making that determination algorithmically, it will flag that particular part within a given repair estimate as a conflicted part. This flag alerts a different module within the Parts Services Layer, 116, to present this cross-referencing failure to a human operator with experience in the automotive parts industry. These operators act as Conflict Resolution, 118, personnel, and try to properly cross-reference the conflicted parts, using their extensive knowledge of the part numbering system in OEM, aftermarket and used automobile part worlds. 2) The second type of “artificial intelligence” is employed when the current invention algorithmically determines that an OEM or aftermarket part number 1234567 must be cross-referenced to that of a used part number 222333444. This information is, once again, stored in a database within the current invention. At a later time, if the current invention is presented with the OEM part number 1234567, it immediately knows that this part number has the used part equivalent 222333444, without the need to go through its sophisticated set of algorithms which may, or may not yield results depending on many other characteristics of the line-item and the repair estimate for which the OEM part number 1234567 is being cross-referenced.

Once a Bundle of parts is created through the preceding operations of the current invention, it must be populated by actual parts from an up-to-date inventory of used automobile parts suppliers. The Search and Populate procedure, 130, of the current invention is carried out based on a number of different settings. These settings are for the most part preferences that are set by insurance companies and/or repair facilities to affect the search process (see FIG. 9—Insurance Company Search Settings).

The Insurance Company Search Settings—FIG. 9, includes settings such as the rating of the part supplier, 902, Freshness of their inventory data, 904, desired warranty on the parts, 906, the maximum distance (or proximity of the repair facility) to which the parts must be delivered, 908, quantity of the parts in the supplier's inventory, 910, whether or not all the parts from the Bundle can be obtained from multiple (up to 3) suppliers, or they must all be obtained from the same supplier, 912. If the settings specify that “all parts must come from the same supplier”, no secondary or tertiary suppliers will be included in the Bundle. The Insurance Company Search Settings page also allows specification of “unwanted”, or “unacceptable” parts, 914, for the search criteria. These parts are automatically excluded from the search algorithms. These are usually parts that the insurance company finds undesirable as used replacements. Examples include: airbag, glass, etc.

The search and populate method is carried out using the Insurance Company Search Settings—FIG. 9. This method searches the database of providers who have partnered with the current invention's company to provide used part pricing and availability information. These used parts databases contain up-to-date used parts inventory information, and enable the current invention to create parts Bundles that match the criteria specified by insurance companies and/or repair facilities. Ultimately, the best Bundle for a given estimate is chosen and either attached to an estimate as an accessible URL, sent as a fax, an e-mail, or converted into a repair estimate supplement, and forwarded to the designated repair facility for inclusion into the repair estimate for which the Bundle was produced.

Once a repair facility or an insurance adjuster receives a copy of the Bundle, he or she can easily browse the Bundle using the current invention's Bundle Viewer, interface, (FIG. 5—Bundle Viewer), evaluate its content, and contact the supplier specified in the Bundle in order to have his or her questions answered, make arrangements for payment, shipping, and delivery of the parts listed in that Bundle. Furthermore, the current invention allows a repair facility to purchase the entire Bundle using an e-commerce module built within the current invention.

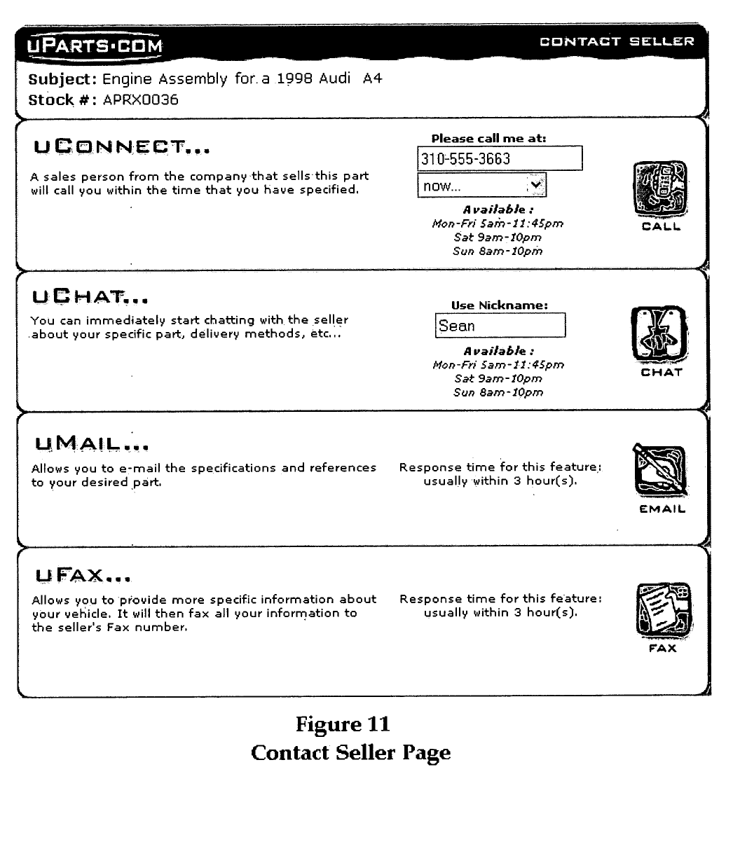

The Bundle Viewer, FIG. 5, becomes the centerpiece of communication for all the various parties to the repair process. For example, the Bundle Viewer, employs a sophisticated telephony application called uConnect. Once a Bundle is received by a recipient (an insurance adjuster, a repair shop personnel, or a part supplier) they can contact each other. In one embodiment of the current invention, repair shops can contact the suppliers, or sellers by clicking the “Contact Seller” button, 516, on the Bundle Viewer interface. This action, will display the “Contact Seller Page”—FIG. 11. Clicking on the “Call” button of this page, activates the uConnect module of the current invention.

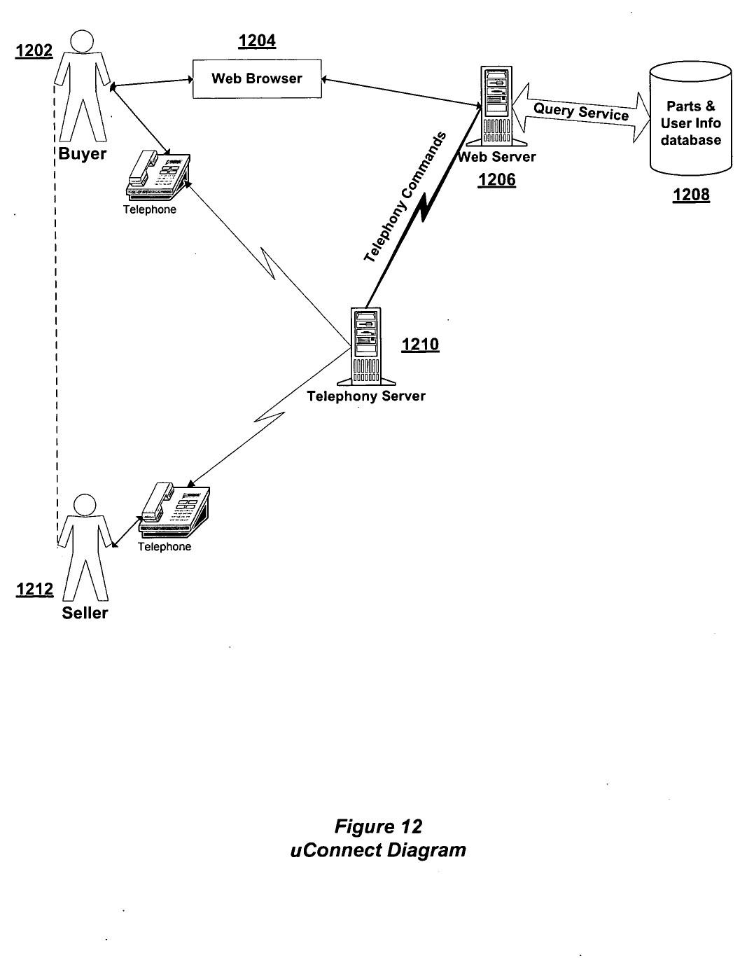

The uConnect functionality of the current invention, depicted in FIG. 12, will begin with one party, 1202, initiating a call by clicking on a button within a user interface, preferably using a web browser, 1204. The web browser, will in turn instruct a web server, 1206, to lookup pertinent call information from a database of user profiles, and part information, 1208, and send telephony commands to a telephony server, 1210, to initiate a call to the other party to the call, 1212, (in this case the seller). The seller will then pick up the phone, and hear a short message indicating the desire of the buyer to talk to him or her. The seller, 1212, will then press a number on the telephone's number pad indicating his or her desire to converse with the buyer. The telephony server, 1210, will then initiate a secondary call to the buyer, 1202, playing a similar message, telling him or her that the seller, 1212, is on hold and waiting to talk to him or her. The buyer, 1202, will then press a key on his or her phone touchpad to confirm his or her desire to talk to the Seller. At this point, the telephony server, 1210, will patch the two individuals together, allowing them to carry out a conversation. All of the operations of this embodiment of the current invention take place within a few seconds. Depending on people's response rate, a call can be initiated within 5 to 20 seconds, from the time the initiating user pressed the call button on his or her web browse interface.

The present embodiment of the current invention is capable of playing text-to-speech messages relating to auto parts, or other products under inquiry by the buyer. It can further record the conversation between the two parties as necessary. For example, the telephony server, 1210, can play (using text-to-speech) part information to the seller, allowing the seller, 1212, to lookup that information (from his Inventory Management System) prior to taking the call from the buyer. Once the seller, 1202 hears the part information, and potentially matches that it on his or her Inventory Management System, he or she can press the touchpad key on his or her phone, indicating his or her acceptance of the call. As soon as the key is pressed, the, telephony server, 1210, will make a phone call to the initiator of call. Once the call initiator picks up the phone and confirm his desire to speak with the other party, the telephony server, 1210, will patch the two parties together. This allows the current invention to keep track of all requests, and correspondence between the seller, and the buyer, or other parties to the call, while keeping the identity of the seller somewhat anonymous. A commercial advantage of using uConnect is its ability to connect a buyer and a seller anonymously, while keeping track of all activities between the buyer and the seller. This will discourage the buyer and seller from completing their transactions independent of the marketplace housing the current invention. For example this may occur, if the parties are trying to avoid paying a commission to the marketplace housing the current invention, or other reasons.

As described above, the current invention performs its analysis, cross-referencing of the OEM/aftermarket parts with their equivalent used parts, and search and location of such parts within seconds. It substantially reduces, and in many cases eliminates, the need for a human operator to cross-reference OEM/aftermarket parts to their equivalent used parts. This increases the effectiveness of used parts location and procurement, since it allows an insurance company adjuster, or other parties to locate the best parts from the closest, and highest rated suppliers within seconds, without the need to contact them through the phone, e-mail, or fax, and wait for their response each time they are being contacted.

The above described processes enable a computer system to dynamically identify used parts for vehicles and to automatically locate these parts. More particularly, the above-described embodiments relate to dynamically and automatically identifying used vehicle (e.g., automobile) parts corresponding to new or Original Equipment Manufacture (OEM)/After Market (AM) automobile parts. Although the above embodiments have been described with respect to automobiles and trucks, the present invention is not limited to automobiles and can be used to identify and locate used parts for any vehicle, which is defined herein to include “any type of motor or non-motor operated vehicle, including without limitation, automobile, truck, motorcycle, boat, airplanes, spaceships, trains, submarines, naval carriers, military vehicles, bicycles, etc., that are made up of new, OEM and/or AM parts and/or corresponding used parts.”

A computer-implemented method is provided, which comprises receiving an electronic vehicle repair estimate with a new part; type cross referencing a type of the new part in the estimate with a type of a used part, according to a used part type database; cross referencing the type of the used part with a used part identifier, according to a used part identifier database; identifying actual used parts corresponding to the new part by searching a used parts database based on the used parts identifier. The used part identifier is a HOLLANDER INTERCHANGE NUMBER, which is accessible through a license from ADP-HOLLANDER, INC.

The used part system shown in FIG. 1 and described herein is implemented in software (as stored on any known computer readable media) and/or computing hardware controlling different computing devices (any type of computing apparatus, such as (without limitation) a personal computer, a server and/or a client computer in case of a client-server network architecture, networked computers in a distributed network architecture).

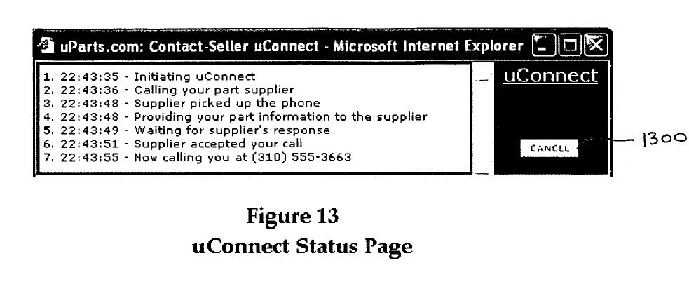

The uConnect Status Page—FIG. 13, depicts the various actions that the uConnect system goes through during its operation. For example, this page keeps the initiator of the uConnect operation informed as to its current actions, allowing him or her to cancel the uConnect operation by pressing the cancel button 1300.

Although a few example embodiments of the present invention have been shown and described, it would be appreciated by those skilled in the art that changes may be made in these embodiments without departing from the principles and spirit of the invention, the scope of which is defined in the claims and their equivalents.

1. A computer-implemented method, comprising:
receiving an electronic vehicle repair estimate with a new part;
type cross referencing a type of the new part in the estimate with a type of a used part, according to a used part type database;
cross referencing the type of the used part with a used part identifier, according to a used part identifier database;
identifying actual used parts corresponding to the new part by searching a used parts database based on the used parts identifier.

2. The method of claim 1, wherein the used part identifier utilizes the HOLLANDER INTERCHANGE PART NUMBERING SYSTEM.

3. The method in claim 1, wherein the type cross-referencing comprises using regular expressions to match keywords specified in a free-text description of the repair estimate, with keywords, or keyword equivalents, defining used part types in a used parts type database.

4. The method in claim 1, wherein the cross-referencing utilizes a vehicle identification number (VIN) in the electronic repair estimate, and VINs provided in the database of actual used auto parts.

5. The method in claim 1, further comprising:
storing in a new-to-used database the used part identifier and the new part identifier, according to the cross-referencing, wherein a subsequent cross-referencing of a used part to a new part uses the stored cross-references in the new-to-used database.

6. The method in claim 1, wherein the cross-referencing is based on a range of vehicles identified according to a vehicle identification number (VIN) in the repair estimate, based upon an actual used parts database.

7. The method of claim 6, wherein last 6 characters of the VIN number are used to best identify the correct used parts for the given vehicle.

8. The method of claim 1, wherein the cross-referencing comprises extrapolating used parts knowledge from the actual used auto parts database based upon the vehicle identification number (VIN) in the repair estimate.

9. The method in claim 1, wherein the cross-referencing comprises analyzing a description field of HOLLANDER INTERCHANGE PART NUMBERING SYSTEM to determine the used part identifier corresponding to the new part, based upon a make, model, year, and/or vehicle identification number (VIN) in the repair estimate.

10. The method of claim 1, wherein the cross referencing comprises a plurality of cross-referencing processes from the most categorical process to the most probabilistic process.

11. The method of claim 1, wherein if two used part identifiers are identified as belonging to different sides of the vehicle in the cross referencing, one of the used part identifiers is selected according to the repair area information in the repair estimate.

12. The method of claim 1, wherein the identification of the actual used parts comprises:
generating a list of used part identifiers according to the used part identifier cross-referencing, as a used part bundle; and
searching the actual used parts database according to the used part bundle.

13. The method of claim 12, wherein a predefined criteria is applied to the bundle during the searching.

14. The method of claim 13, wherein a search criteria is based on a total value of the new part repair estimate.

15. The method of claim 14, wherein the search criteria further comprises a predefined list of unacceptable parts supplied by an insurance carrier and/or a repair facility.

16. The method of claim 13, wherein the predefined search criteria is dynamically adjusted according to a predefined list of preferred used parts suppliers.

17. The method of claim 16, wherein the search criteria is adjusted according to a proximity of a used parts supplier and/or actual used parts to a repair facility generating the new part repair estimate and/or a delivery destination of the actual used parts to be located according to the searching.

18. The method of claim 12, further comprising:
filtering a search result of the searching to exclude unacceptable condition keywords for a located actual used part, wherein the unacceptable condition keywords comprise broken, chipped, burnt, damaged, or any combination thereof.

19. The method of claim 13, wherein a search criteria comprises applying a predefined minimum required savings amount for the bundle with respect to a total value of the new part repair estimate.

20. The method of claim 12, further comprising:
filtering a search result of the searching based on a minimum acceptable price for a located actual used part and/or a maximum acceptable price for a located actual used part, based on the price of the new part estimate.

21. The method of claim 16, further comprising:
filtering a search result of the searching according to a total dollar savings of each used parts supplier with respect to a total value of the new part repair estimate.

22. The method of claim 12, further comprising:
filtering a search result of the searching according to best suppliers chosen from among a plurality of multitude of qualifying used parts suppliers, based on a number of different weighted factors comprising distance, cost savings, rating of a used parts supplier, or any combination thereof.

23. The method of claim 12, further comprising:
allowing a user to add, remove, or change any of the identified used parts in the bundle, and to reinitiate the searching.

24. The method of claim 23, further comprising logging actions of the user to be utilized in subsequent used part type and/or used part identifier cross-referencings.

25. The method of claim 12, further comprising generating a supplement used parts repair estimate to the new part repair estimate according to the bundle.

26. The method of claim 25, wherein the supplement used parts repair estimate interfaces with a repair estimating computer system generating the new part repair estimate.

27. The method of claim 12, further comprising:
users contacting each other, via a communications system, anonymously and directly by clicking on a call button provided on a user interface for the bundle, whereby all interactions among the users is logged and recorded for accountability.

28. The method of claim 12, further comprising:
transmitting the bundle to a recipient;
logging all interactions of the recipient of the bundle for accountability, via a unique identifier in the bundle, wherein the interactions comprise receipt of the bundle, adding used parts, removing used parts, changing, price information, shipping information, attaching of used parts images, other actions related to receipt and procurement of the bundle, or any combination thereof.

29. A computing apparatus, comprising:
a programmed computer processor controlling the computing apparatus according to a process comprising:
receiving an electronic vehicle repair estimate with a new part;
type cross referencing a type of the new part in the estimate with a type of a used part, according to a used part type database;
cross referencing the type of the used part with a used part identifier, according to a used part identifier database;
identifying actual used parts corresponding to the new part by searching a used parts database based on the used parts identifier.
